(19) United States
(12) Patent Application Publication
(10) Pub. No.: US 2012/0197978 A1
(43) Pub. Date: Aug. 2, 2012

(54) Method and System for Seamless Navigation and Drill Back Among a Plurality of Web Applications

(75) Inventors: Manjunath Ganimasty, Norcross, GA (US); Marcio DeBarros, Cumming, GA (US); Polly Chang, Cumming, GA (US); James Willey, Beaufort, NC (US); James Jones, Kendall Park, NJ (US); Stefany Martin, Spartanburg, SC (US)

(73) Assignee: INFOR GLOBAL SOLUTIONS (MICHIGAN), INC., Bingham Farms, MI (US)

(21) Appl. No.: 13/340,858

(22) Filed: Dec. 30, 2011

Related U.S. Application Data
(63) Continuation of application No. 13/332,268, filed on Dec. 20, 2011.
(60) Provisional application No. 61/424,941, filed on Dec. 20, 2010.

(51) Int. Cl. G06F 15/16

(52) U.S. Cl. 709/203

(57) ABSTRACT

A networked computer system and method for drilling back among a plurality of web applications. The networked computer system includes a server serving a plurality of applications and a client-side computer system connected to the server over a network. The client-side computer system includes a browser comprising a plurality of interfaces configured to access a plurality of applications over the network. The browser is configured to display contextual data in a first one of the plurality of interfaces accessing a first one of the plurality of applications and to provide a portion of the contextual data to a second one of the plurality of interfaces accessing a second one of the plurality of applications. The browser provides seamless navigation among the plurality of applications. The method includes steps of interfacing with a plurality of web applications and seamlessly navigating from a first web application to a second web application.

### CROSS REFERENCE TO RELATED APPLICATIONS

This application is a continuation of U.S. Nonprovisional Application No. 13/332,268, entitled “Method and System for Seamless Navigation and Drill Back Among a Plurality of Web Applications” and filed Dec. 20, 2011, which application claims the benefit of U.S. Provisional Application No. 61/424,941, entitled “Method and System for Seamless Navigation and Drill Back Among a Plurality of Web Applications” and filed Dec. 20, 2010, the contents of which applications are incorporated herein by reference.

### FIELD OF THE INVENTION

The present invention relates to a computer interface which provides for seamless integration of a plurality of web applications and, more specifically, to a web browser which provides access to a plurality of web applications in a plurality of frames and which provides for seamless navigation and drill back from one web application accessed in one frame to another web application accessed in another frame.

### BACKGROUND OF THE INVENTION

Large enterprise software systems often include numerous enterprise applications. In some cases, enterprise software systems include so many enterprise applications that it has become very difficult to determine where one application, e.g., enterprise resource planning (ERP), ends and another begins, e.g., supply chain management (SCM), product lifecycle management (PLM), customer relationship management (CRM), enterprise asset management (EAM), etc.

### SUMMARY OF THE INVENTION

In accordance with an aspect of the present invention, there is provided a computer system connected to a server over a network. The computer system includes a browser comprising a plurality of interfaces configured to access a plurality of applications over the network. The browser is configured to display contextual data in a first one of the plurality of interfaces accessing a first one of the plurality of applications and to provide at least a portion of the contextual data to a second one of the plurality of interfaces accessing a second one of the plurality of applications for display in the second one of the plurality of interfaces.

In accordance with another aspect of the present invention, there is provided a networked computer system. The networked computer system includes a server serving a plurality of applications and at least one client-side computer system connected to the server over a network. The at least one client-side computer system includes a browser comprising a plurality of interfaces configured to access a plurality of applications over the network. The browser is configured is to display contextual data in a first one of the plurality of interfaces accessing a first one of the plurality of applications and to provide the contextual data to a second one of the plurality of interfaces accessing a second one of the plurality of applications for display in the second one of the plurality of interfaces.

In accordance with yet another aspect of the present invention, there is provided a method of interfacing to applications over a network. The method includes a step of receiving a plurality of webpages comprising a plurality of interfaces to a plurality of web applications and a step of rendering a first one of the plurality of webpages within a first one of the plurality of interfaces to access a first one of the plurality of web applications. The first one of the plurality of webpages displays contextual data. The method includes further steps of hiding other ones of the plurality of interfaces to hide other ones of the plurality of web applications and seamlessly navigating from the first one of the plurality web applications to a second one of the plurality of web applications in a second one of the plurality of webpages rendered in a second one of the plurality of interfaces in response to a user selection. The second one of the plurality of webpages displays information based on the contextual data presented in the first one of the plurality of webpages.

### BRIEF DESCRIPTION OF THE DRAWINGS

For the purpose of illustration, there are shown in the drawings certain embodiments of the present invention. In the drawings, like numerals indicate like elements throughout. It should be understood, however, that the invention is not limited to the precise arrangements, dimensions, and instruments shown. In the drawings:

FIG. 1 illustrates a user interface comprising a browser for seamlessly navigating among a plurality of web applications, in accordance with an exemplary embodiment of the present invention;

FIG. 2 illustrates a networked computer system comprising a server configured to serve a plurality of web applications to client-side computer systems, the client-side computer systems accessing the plurality of web applications and seamlessly navigating among the plurality of web applications, in accordance with an exemplary embodiment of the present invention;

FIG. 3A illustrates a first frame of the browser illustrated in FIG. 1 accessing a first web application and sending an OnClick message to the browser, the OnClick message, generated in response to user selection, specifying seamless navigation to a second web application, in accordance with an exemplary embodiment of the present invention;

FIG. 3B illustrates a result of seamlessly navigating to the second web application selected in FIG. 3A, the second web application accessed by a second frame of the browser illustrated in FIG. 1, in accordance with an exemplary embodiment of the present invention;

FIG. 4A illustrates a first frame of the browser illustrated in FIG. 1 accessing a first web application and sending an OnClick message to a second frame of the browser, the OnClick message, generated in response to user selection, specifying seamless navigation to a second web application, in accordance with an exemplary embodiment of the present invention;

FIG. 4B illustrates a result of seamlessly navigating to the second web application selected in FIG. 4A, the second web application accessed by a second frame of the browser illustrated in FIG. 1, in accordance with an exemplary embodiment of the present invention;

FIGS. 5A-5K illustrate examples of seamless navigation among a plurality of web applications, in accordance with an exemplary embodiment of the present invention;

FIG. 6A illustrates a first exemplary embodiment of a method for effecting seamless navigation among a plurality of web applications, in accordance with an exemplary embodiment of the present invention;

FIG. 6B illustrates a second exemplary embodiment of a method for effecting seamless navigation among a plurality of web applications, in accordance with an exemplary embodiment of the present invention;

FIG. 7A illustrates a first frame of the browser illustrated in FIG. 1 accessing a first web application and sending a first message to the browser, the first message comprising drill back data, in accordance with an exemplary embodiment of the present invention;

FIG. 7B illustrates a second frame of the browser illustrated in FIG. 1 receiving a second message from the browser and accessing a second web application, the second message containing drill back data corresponding to the drill back data of the first message illustrated in FIG. 7A, in accordance with an exemplary embodiment of the present invention;

FIG. 8A illustrates a first frame of the browser illustrated in FIG. 1 accessing a first web application and sending a first message comprising drill back data to the browser, the browser sending an asynchronous request to the application server of FIG. 2 to provide a drill back URL, in accordance with an exemplary embodiment of the present invention;

FIG. 8B illustrates the server of FIG. 2 responding to the request of FIG. 8A with a callback comprising a drill back URL, the browser forwarding a load command to a second frame of the browser in response to the callback to load the drill back URL, in accordance with an exemplary embodiment of the present invention;

FIG. 8C illustrates a table defining application views and their associated URLs, in accordance with an exemplary embodiment of the present invention;

FIGS. 9A-9B illustrate examples of drilling back between web applications, in accordance with an exemplary embodiment of the present invention;

FIGS. 10A-10C illustrate an exemplary embodiment of a method for effecting drill back between web applications, in accordance with an exemplary embodiment of the present invention; and

FIGS. 11A-11C illustrate a right-pane application in differing states, in accordance with an exemplary embodiment of the present invention.

### DETAILED DESCRIPTION OF THE INVENTION

During an average day, users of enterprise software systems do not limit their use to one enterprise application only. Rather, such users often use many enterprise applications, often simultaneously. Furthermore, they may also spend time using desktop tools, on an Intranet, and out on the Internet. The multitude of software applications a user may use during an average day often leads to a cluttered computer screen.

As noted above, in the case of large enterprise software systems, the large number of enterprise applications may make it difficult to determine where one application ends and another begins. The multitude of enterprise applications may lead to a cluttered computer screen and difficulty in navigating among the applications. Accordingly, in view of the foregoing, it would be desirable to provide for seamless navigation among software applications within a single browser.

As understood in the art, a website is a collection of web pages served on a particular domain or subdomain on the World Wide Web. Each web page is generally associated with a uniform resource locator (“URL”) which identifies the resources associated with the web page. Such resources include static content, such as HyperText Markup Language (“HTML”) code or eXtensible HyperText Markup Language (“XHTML”), and dynamic content, such as software code or scripts which generates HTML and/or XHTML, for example.

The website, or, more generally, the resources associated with a URL, may be served by one or more servers to connected users who submit requests to view particular web pages or resources associated with particular URLs. In an exemplary embodiment, the web pages may provide an interface to web applications hosted in a browser-controlled environment (e.g. a Java applet). In another exemplary embodiment, access to the web application may be coded in a browser-supported language (such as JavaScript, combined with a browser-rendered markup language like HTML).

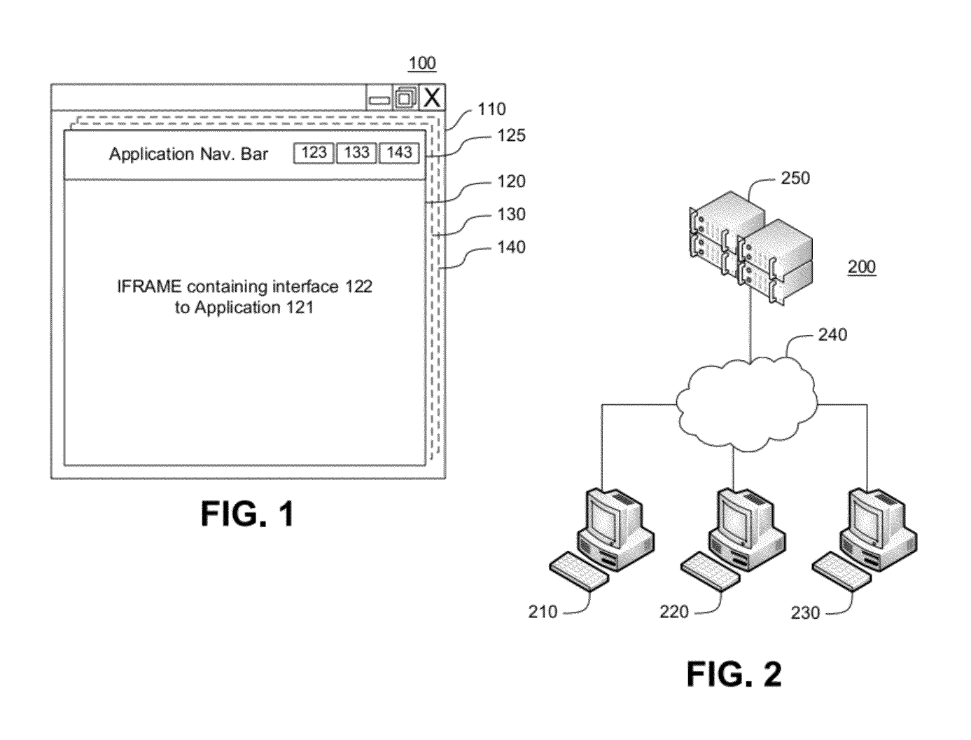

Referring now to FIGS. 1 and 2, there are illustrated a browser 100 and a networked computer system 200, in accordance with an exemplary embodiment of the present invention. The browser 100 is executed on a computer system 210 to display resources accessed by a URL, such as a web page 110 (illustrated in FIG. 1) hosted by a server 250 (illustrated in FIG. 2). In an exemplary embodiment, the browser 100 is a web browser which interprets browser code to render the web page 110 displayed within the browser 100.

The web page 110 comprises browser code comprising a plurality of frames 120, 130, and 140. Each of the frames 120, 130, and 140 accesses a web page hosted by the server 250. Each web page provides access to a web application served by the server 250 and displays an interface to such web application. In the exemplary embodiment illustrated in FIG. 1, the web page 110 is hosted by the server 250 and selectively displays a first frame 120, which, when rendered and displayed, provides a first interface 122 to a first web application 121 served by the server 250. Additionally, the web page 110 selectively displays a second frame 130, which, when rendered and displayed, provides a second interface 132 to a second web application 131 served by the server 250. Further, the web page 110 selectively displays a third frame 140, which, when rendered and displayed, provides a third interface 142 to a third web application 141 served by the server 250.

In the exemplary embodiment illustrated in FIG. 2, there is illustrated one server which hosts a website including the web page 110 and which serves the plurality of web applications accessed by the computer system 210 via the web page 110 and the frames 120, 130, and 140. It is to be understood that more than one server may be used to implement the delivery of content to the computer system 210 and the delivery of access of the computer system 210 to the web applications. In a further exemplary embodiment, the server 250 comprises a web server, which delivers the web page 110 to the computer system 210, and an application server, which executes the web applications and provides interfaces to such web applications to the computer system 210 via the web page 110. In an exemplary embodiment, the frames 120, 130, and 140 embedded in the browser code delivered with the web page 110 are inline frames (“iframes”) which render separate browser code, e.g., web pages, to provide their respective interfaces 122, 132, and 142 to the respective web applications 121, 131, and 141. In such exemplary embodiment, the interface 122 is a first web page; the interface 132 is a second web page; and the interface 142 is a third web page. The first web page 122 accesses the first web application 121; the second web page 132 accesses the second web application 131; and the third web page 142 access the third web application 141.

As illustrated in FIG. 1, the first frame 120 comprises an application navigation bar 125 comprising links to the frames 120, 130, and 140 and, thereby, to the web applications available for access within the browser 100. In the example illustrated in FIG. 1, the application navigation bar 125 comprises application links 123, 133, and 143. The application link 123 is a link to the web application 121; the application link 133 is a link to the web application 131; and the application link 143 is a link to the web application 141. It is to be understood that description, herein, of a link to a web application means a link to an interface, e.g., a web page, providing access to such web application. Description herein of a link to a frame is also synonymous with a link to an interface, e.g., a web page, providing access to a web application via such frame. Thus, with more particularity, the application link 123 is a link to the frame 120 and, in embodiments in which the frame 120 is an iframe, to the web page providing access to the first web application within the frame 120. The application link 133 is a link to the frame 130 and, in embodiments in which the frame 130 is an iframe, to the web page providing access to the second web application within the frame 130. The application link 143 is a link to the frame 140 and, in embodiments in which the frame 140 is an iframe, to the web page providing access to the third web application within the frame 140.

A user of the browser 100 navigates the browser 100 among the frames 120, 130, and 140 and, thereby among the web applications 121, 131, and 141 accessed within the interfaces 122, 132, and 142 accessed by respective frames 120, 130, and 140. The browser 100, with the assistance of the server 500, effects seamless navigation among the frames 120, 130, and 140 in accordance with methods 600A and 600B described below.

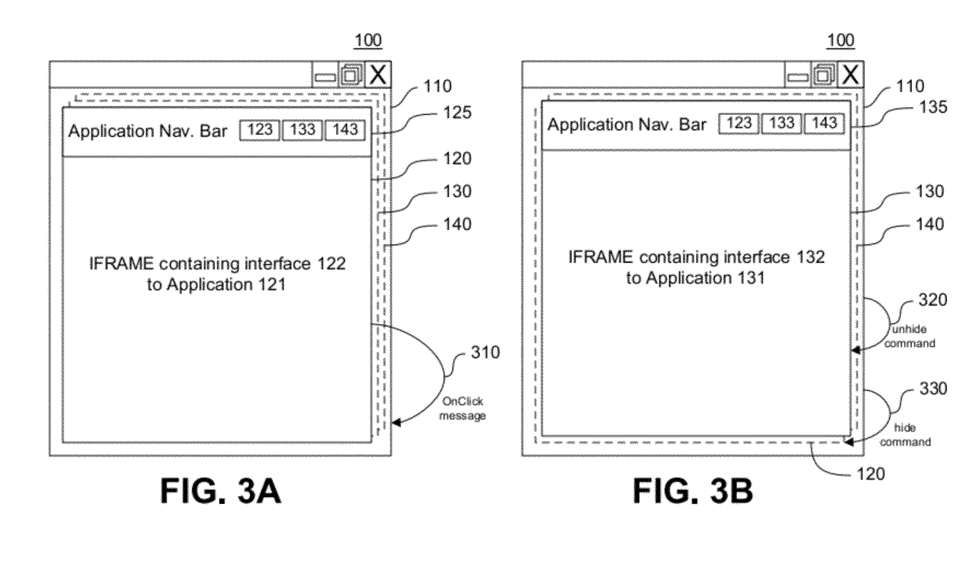

Each of the frames 120, 130, and 140 includes an application navigation bar. In the exemplary embodiment illustrated in FIG. 1, the application navigation bar for the frame 120 is designated as 125. The application navigation bar for the frame 130 is designated as 135 and is illustrated in FIG. 3B. The application navigation bar for the frame 140 is designated as 145, although not illustrated in the figures. Each of the application navigation bars 125, 135, and 145 comprises the links 123, 133, and 143, which link, respectively, to the frames 120, 130, and 140. Each of the application navigation bars 125, 135, and 145 have a similar appearance, e.g., any descriptive text within the application navigation bars is similar and the links 123, 133, and 143 are located in similar positions, so that as a user browses from one frame 120, 130, or 140 to another frame 120, 130, or 140, the user sees what appears to be a static application navigation bar at the top of the frame appearing in the browser 100. In an exemplary embodiment, the links 123, 133, and 143 have the same respective positions in all of the application navigation bars 125, 135, and 145, and the application navigation bars 125, 135, and 145 have identical text in identical positions. Thus, as the user seamlessly navigates among the frames 120, 130, and 140, the application navigation bars appearing in the frames appears to be a single application navigation bar.

Referring now to FIG. 2, there is illustrated an exemplary networked computer system 200, in accordance with an exemplary embodiment of the present invention. The networked computer system 200 comprises a plurality of client-side computer systems 210, 220, and 230 connected to the server 250 through a network 240. The network 240 may comprise any network known in the art, for example the Internet, a LAN, etc.

The server 250 serves the web page 110 and the plurality of web applications 121, 131, and 141 accessed via the client-side computer systems 210, 220, and 230 through a web page as it is rendered within a browser executed by each of the client-side computer systems 210, 220, and 230. For example, the client-side computer system 210 may execute the browser 100 to retrieve and render the web page 110 to access the web applications 121, 131, and 141, as described above. The client-side computer systems 220 and 230 may similarly execute a browser to retrieve and render web pages to access the web applications 121, 131, and 141, as described above.

It is to be understood that the system 200 is not limited to serving only three web applications 121, 131, and 141 and providing access to those web applications 121, 131, and 141 via three frames 120, 130, and 140 and three interfaces 121, 132, and 142. Rather, it is contemplated that the system 200 is configured to serve any number of web applications and to provide access to such web applications via any number of frames and interfaces.

The server 250 may simultaneously execute the plurality of web applications 121, 131, and 141 and simultaneously serve the plurality of interfaces 122, 132, and 142. The web applications 121, 131, and 141 and the interfaces 122, 132, and 142 are programmed using any one of a plurality of software technologies. The client side computer systems 210, 220, and 230, by accessing the plurality of applications via the browsers 100, are isolated from the code requirements of the applications, because the applications are executed on the server side. At the same time, the web page 110 provides a unified interface to the plurality of web applications 121, 131, and 141, even if access to such web applications 121, 131, and 141 is made via different software technologies. For example, the first interface 122 to the first web application 121 may be an applet, while the second interface 132 to the second web application 131 may make use of JavaScript or AJAX, and the third interface 142 to the third web application 141 may be a Java client. By presenting the interfaces 122, 132, and 142 within the same browser 100, the user of the browser experiences seamless navigation among the varying software technologies. In fact, to the user, all of the web applications 121, 131, and 141 appear to be seamlessly integrated within a single user interface. It is to be understood that any of the web applications 121, 131, and 141 may also follow the ASP.NET framework.

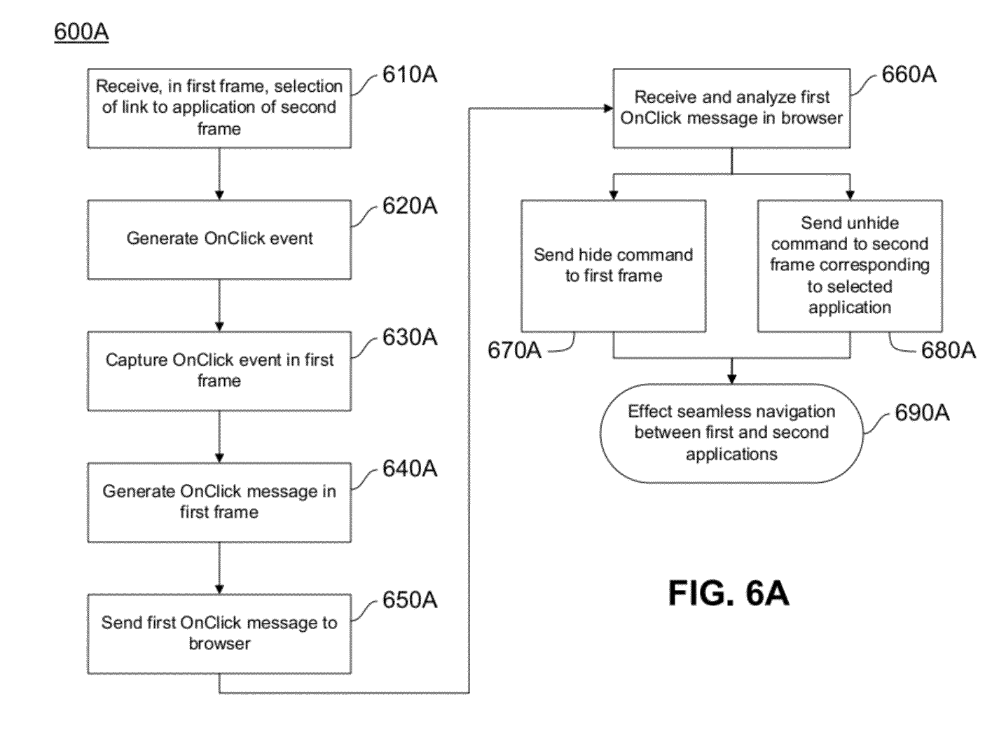

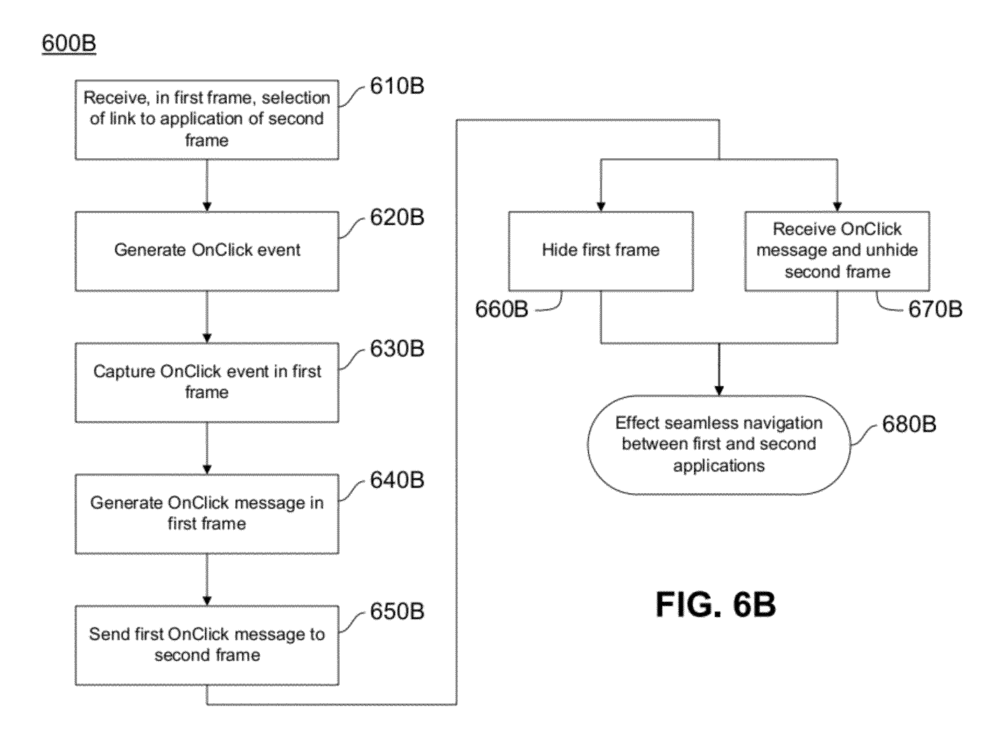

Referring now to FIGS. 3A and 3B, there are illustrated messages sent within the browser 100 to effect seamless navigation among the frames 110, 120, and 130, in accordance with an exemplary embodiment of the present invention. FIGS. 3A and 3B are now described with reference to FIG. 6A, which illustrates a first method 600A of seamlessly navigating among the frames 110, 120, and 130 using the messages illustrated in FIGS. 3A and 3B, in accordance with an exemplary embodiment of the present invention.

FIG. 3A illustrates a first message 310 sent by the first frame 120 to the browser 100. The first message 310 is an OnClick message specifying a web application, selected within the first frame 120, to which the browser 100 is to seamlessly navigate. Because each web application is accessed in a respective frame within the browser 100, the OnClick message may also be said to specify a frame or interface, selected within the first frame 120, to which the browser 100 is to seamless navigate. The selected web application corresponds to the selected frame.

FIG. 3B illustrates a first command 320 sent by the browser 100 to the second frame 130 and a second command 330 sent by the browser 100 to the first frame 120. The first command 320 is an unhide command specifying an application, selected within the first frame 120, to unhide. The second command 330 is a hide command specifying the application 121 of the first frame 120 to hide itself. As described below with respect to FIG. 6A, the hide command 330 commands the first frame 120 to hide itself as the unhide command 320 commands the second frame 130 to unhide itself. The hiding of the first frame 120 at the same time as the unhiding of the second frame 130 presents a seamless navigation within the browser 100 between such frames. Thus, FIG. 3B also illustrates a result of seamless navigation from the first frame 120 to the second frame 130. The seamless navigation appears to the user that the displayed contents of the webpage 110 outside of the application navigation bar 125 are replaced after an application link is clicked within the navigation bar.

The method 600A of seamlessly navigating between the first application 121 and the second application 131, for example, is now described with reference to FIGS. 3A and 3B. When the browser 100 is in its initial state, the web page 110 displays the first frame 120 and the first application 121 accessed within it, as illustrated in FIG. 3A. The second frame 130 and the third frame 140 are hidden from view. In a Step 610A, the user clicks or selects a link within the application navigation bar 125 in the first frame 110. In the examples illustrated in FIGS. 3A-3B, the user clicks or selects the link 133 directed to the application 131 of the second frame 130.

The selection of the link 133 generates an OnClick event, Step 620A. The first frame 130 captures the OnClick event, Step 630A and, in response, generates the first message 310, Step 640A. The first message 310 specifies the link selected in the frame and, optionally, the frame in which the first message 310 is generated. In the example illustrated in FIG. 3A, the first message 310 specifies the link 133 as being selected in the frame and, optionally, the first frame 120 as generating the message 310. For purposes of discussion below, description of selection of the link 133 and like description is used interchangeably with description of selection of the application 131 and selection of the second frame 130, where context permits. More generally, description of selection of a web application link and like description is used interchangeably with description of selection of an application and selection of a frame, where context permits.

Continuing with the method 600A, after generating the first message 310, the first frame 120 sends the first message 310 to the browser 100, Step 650A. The browser 100 receives the first message 310 and analyzes the contents of the first message 310, Step 660A. In the example illustrated in FIGS. 3A and 3B, the browser 100 determines that the first message 310 specifies the link 133 as being selected in the first frame 120. As a result of such analysis, the browser 100 sends the hide command 330 to the first frame 120, Step 670A, and the unhide command 320 to the second frame 130, Step 680A, at the same time to effect a seamless navigation between the frames 120 and 130, Step 690A. Specifically, the frame 120 hides itself as the frame 130 unhides itself in the Step 690A to effect the seamless navigation between the frames.

In an exemplary alternative embodiment, the first frame 120 is a first frame object programmed within the web page 110, and the second frame 130 is a second frame object programmed within the web page 110. In such an embodiment, the web page 110 may contain, or link to, JavaScript comprising script for manipulating such frame objects or Java code for manipulating such frame objects. In such an embodiment, the unhide command 320 may comprise an invocation, by the browser 100, of the setVisible( ) method of the second frame object to unhide the second frame 130, and the hide command 330 may comprise an invocation, by the browser 100, of the setVisible( ) method of the first frame object to hide the first frame 120. Thus, in such an embodiment, the Step 670A of the method 600A comprises a step of the browser 100 invoking the setVisible( ) method of the second frame object to unhide the second frame 130, and the Step 680A of the method 600A comprises a step of the browser 100 invoking the setVisible( ) method of the first frame object to hide the first frame 120. The steps 670A and 680A invoke the setVisible( ) methods of the first and second frame objects simultaneously to effect seamless navigation between the first and second applications 121, 131 in the Step 690A. In an exemplary embodiment, the message 310 comprises an invocation, by the frame 120, of a method of a browser object, which method comprises invocations, by the browser 100, of the setVisible( ) method of each of the first and second frame objects, as described above.

In a further exemplary alternative embodiment, the web page 110 captures the OnClick event generated when the user selects an application, within the first frame 120, to which the browser 100 is to seamlessly navigate, rather than the first frame 120 capturing the OnClick event. For example, the web page 110 captures the OnClick event generated in response to the user selecting the link 133. In such an embodiment, the Steps 630A-650A are omitted, and the Step 660A comprises capturing the OnClick event, generated in the Step 610A, in the browser 100 and analyzing the OnClick event therein. The method 600A may then proceed, as previously described, by sending the hide command 330 in the Step 670A to the first frame 120 and the unhide command 320 in the Step 680A to the second frame 130, or the method 600A may then proceed, as described in the exemplary alternative embodiment above, by invoking, in the Step 670A, the setVisible( ) method of the first frame object to hide the first frame 120, and by invoking, in the Step 680A, the setVisible( ) method of the second frame object to unhide the second frame 130.

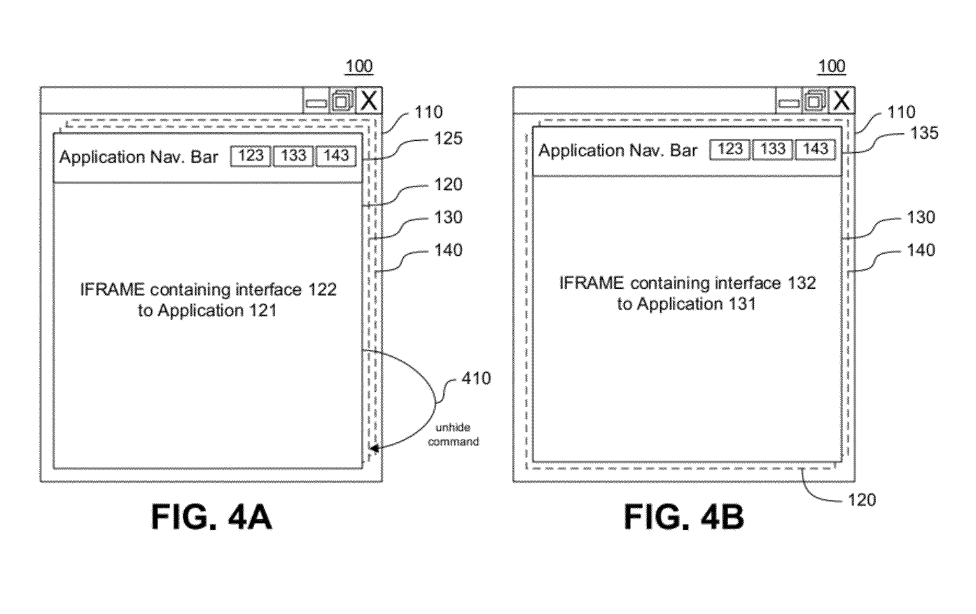

Referring now to FIGS. 4A and 4B, there is illustrated an alternative embodiment of messages sent within the browser to effect seamless navigation among the frames 110, 120, and 130, in accordance with an exemplary embodiment of the present invention. FIGS. 4A and 4B are now described with reference to FIG. 6B, which illustrates a second method 600B of seamlessly navigating among the frames 120, 130, and 140 using the messages illustrated in FIGS. 4A and 4B, in accordance with an exemplary embodiment of the present invention.

FIG. 4A illustrates a first message 410 sent by the first frame 120 to the second frame 130. The first message 410 is an OnClick message specifying a web application, selected within the first frame 120, to which the browser 100 is to seamlessly navigate. Because each web application is accessed in a respective frame within the browser 100, the OnClick message may also be said to specify a frame or interface, selected within the first frame 120, to which the browser 100 is to seamless navigate. The selected web application corresponds to the selected frame.

FIG. 4B illustrates a result of seamless navigation from the first frame 120 to the second frame 130. As described below with respect to FIG. 6B, the first message 410 instructs the second frame 130 to unhide itself. At the same time, the first frame 120 hides itself. As with FIGS. 3A and 3B, the hiding of the first frame 120 at the same time as the unhiding of the second frame 130 in FIGS. 4A and 4B presents a seamless navigation within the browser 100 between such frames. The seamless navigation appears to the user as the contents of the webpage 110 outside of the application navigation bar 125 being replaced after an application link is clicked within the navigation bar 125.

The method 600B of seamlessly navigating between the first application 121 and the second application 131, for example, is now described with reference to FIGS. 4A and 4B. When the browser 100 is in its initial state, the web page 110 displays the first frame 120 and the first application 121 accessed within it, as illustrated in FIG. 4A. The second frame 130 and the third frame 140 are hidden from view. In a Step 610B, the user clicks or selects a link within the application navigation bar 125 in the first frame 110. In the examples illustrated in FIGS. 4A-4B, the user clicks or selects the link 133 directed to the application 131 of the second frame 130.

The selection of the link 133 generates an OnClick event, Step 620B. The first frame 130 captures the OnClick event, Step 630B and, in response, generates the first message 410, Step 640B. The first message 410 specifies the link selected in the frame and, optionally, the frame in which the first message 410 is generated. In the example illustrated in FIG. 4A, the first message 410 specifies the link 133 as being selected in the frame and, optionally, the first frame 120 as generating the message 410.

Continuing with the method 600B, after generating the first message 410, the first frame 120 sends the first message 410 directly to the second frame 130, Step 650B. The second frame 130 receives the first message 310 and analyzes the contents of the first message 410, Step 670B. In the example illustrated in FIGS. 4A and 4B, the second frame 130 determines that the first message 410 specifies the link 133 in the first frame 120 as being selected. As a result of such analysis, the second frame 130 unhides itself, Step 670B. At the same time, the first frame 120 hides itself, Step 660B. Thus, the frames 120 and 130 effect a seamless navigation between the frames 120 and 130, Step 680B. Specifically, the frame 120 hides itself at the same time as the frame 130 unhides itself to effect the seamless navigation between the frames in the Step 680A.

In an exemplary alternative embodiment, the first frame 120 of FIG. 4 is a first frame object programmed within the web page 110, and the second frame 130 of FIG. 4 is a second frame object programmed within the web page 110. In such an embodiment, the web page 110 may contain JavaScript comprising script for such frame objects or Java code for such frame objects. In such an embodiment, the unhide command 410 may comprise an invocation, by the first frame 120, of the setVisible( ) method of the second frame object to unhide the second frame 130. Thus, in such an embodiment, the Steps 640B and 650B are omitted; the Step 670B of the method 600B comprises a step of the first frame 120 invoking the setVisible( ) method of the second frame object to unhide the second frame 130; and the Step 660B of the method 600B comprises a step of the first frame 120 invoking the setVisible( ) method of the first frame object to hide itself. The steps 660A and 670A invoke the setVisible( ) methods of the first and second frame objects simultaneously to effect seamless navigation between first and second applications 121, 131 in the Step 680B.

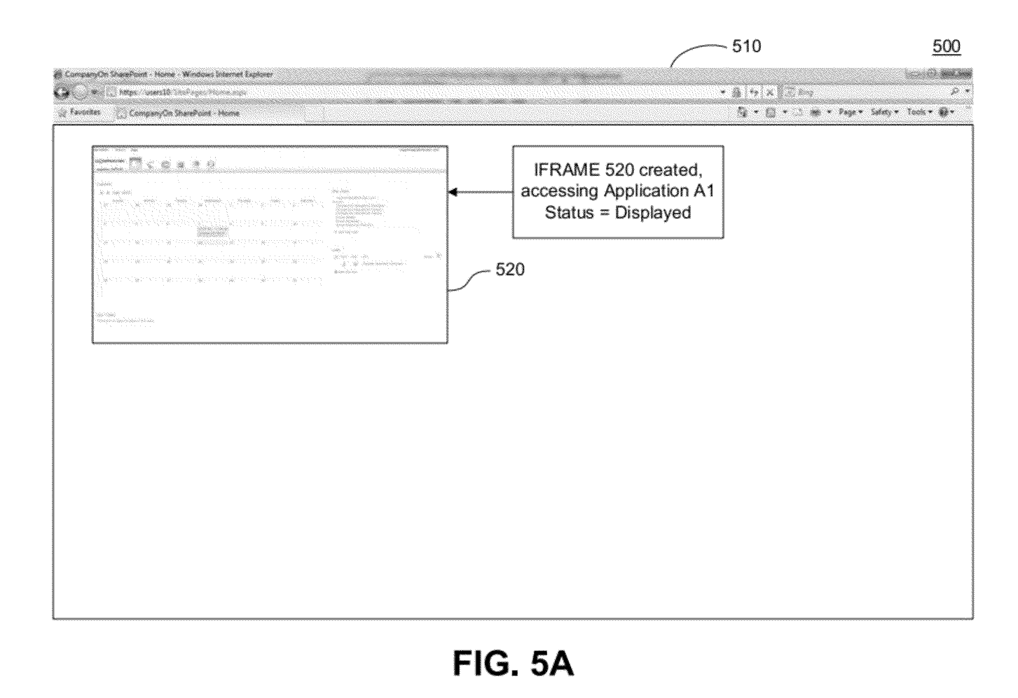

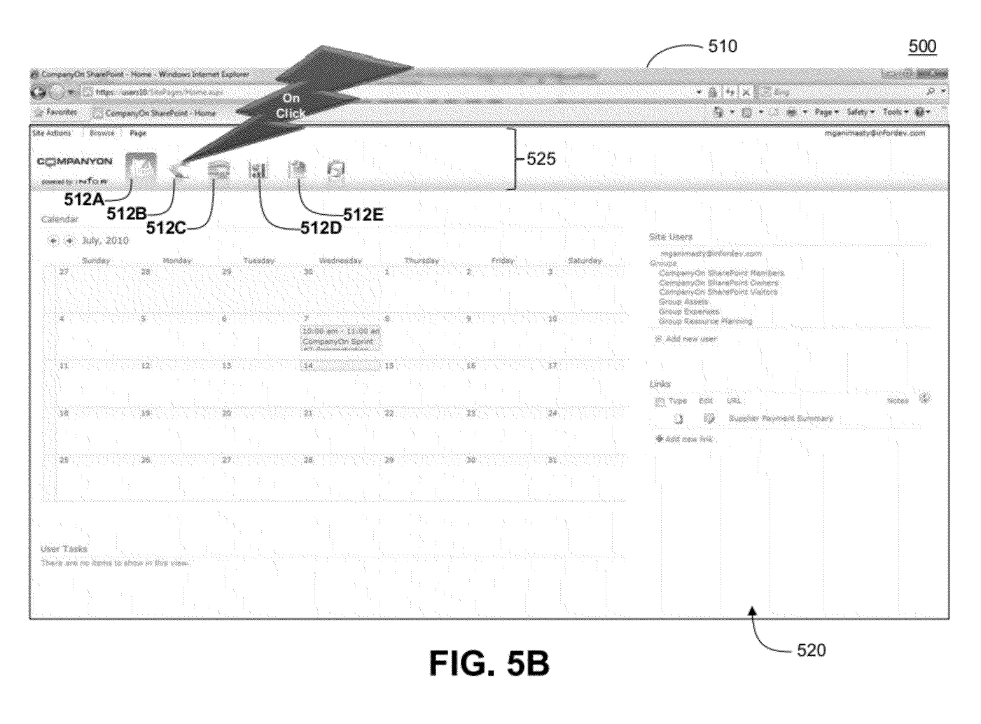

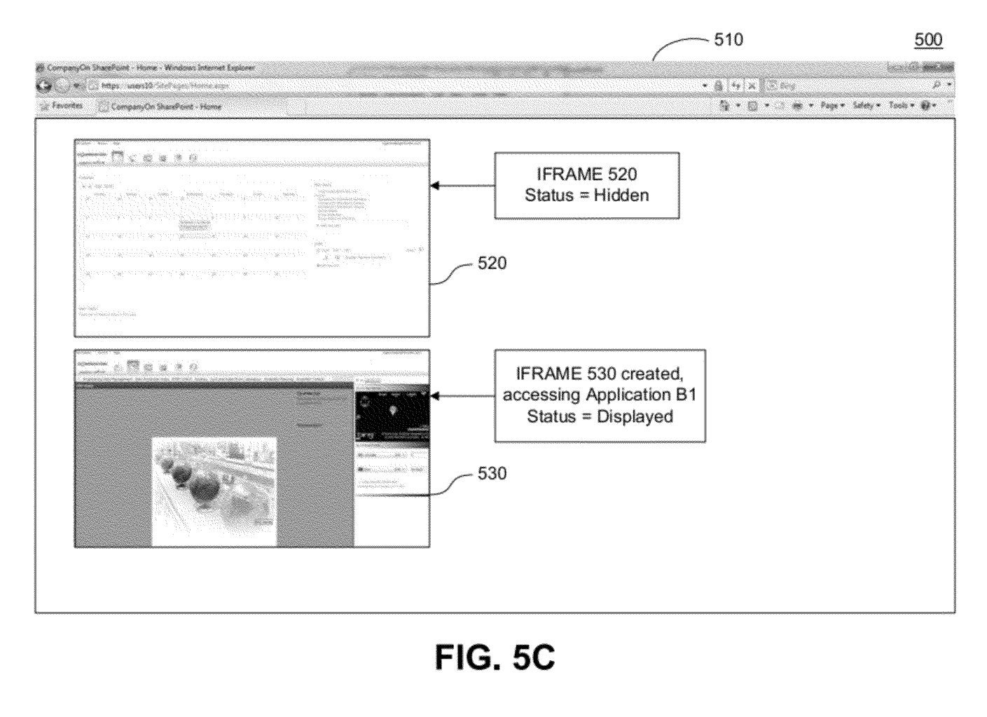

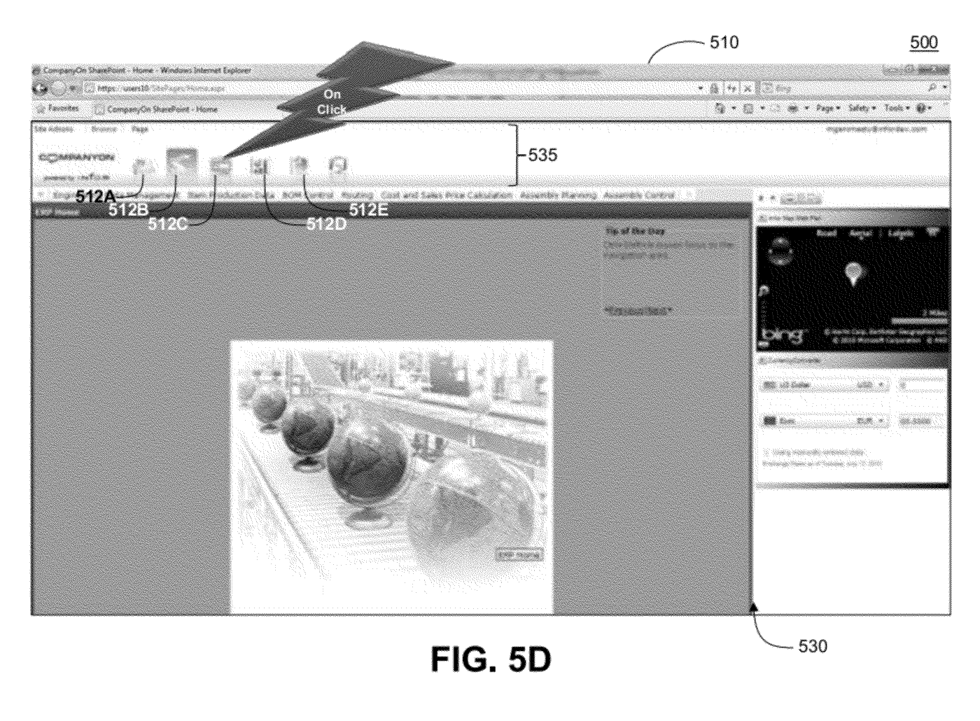

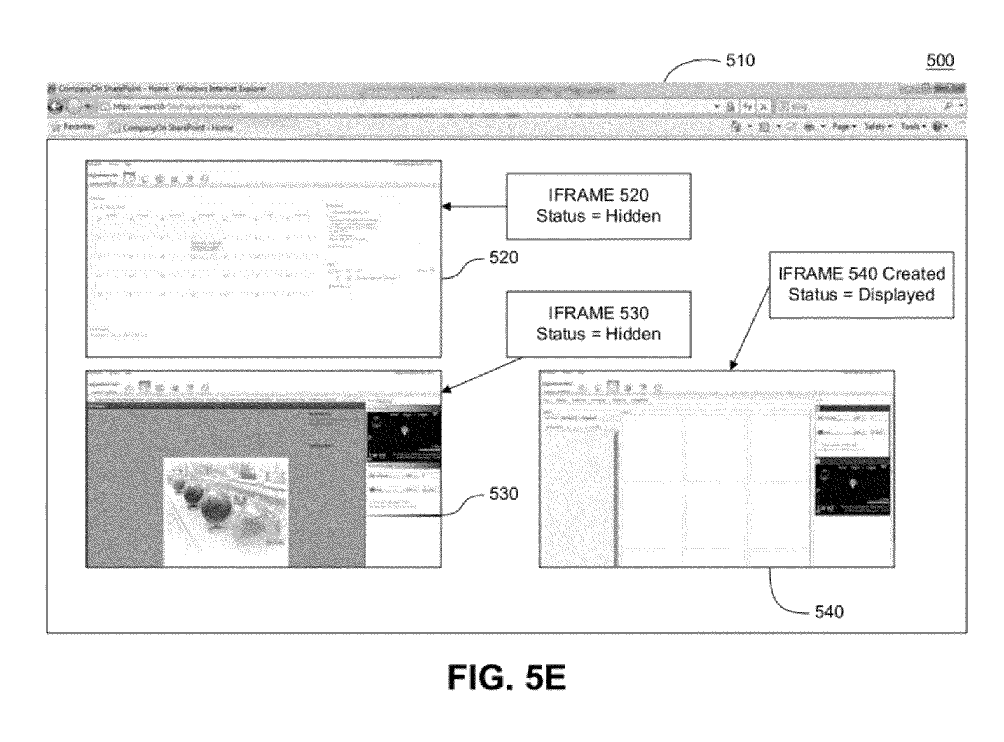

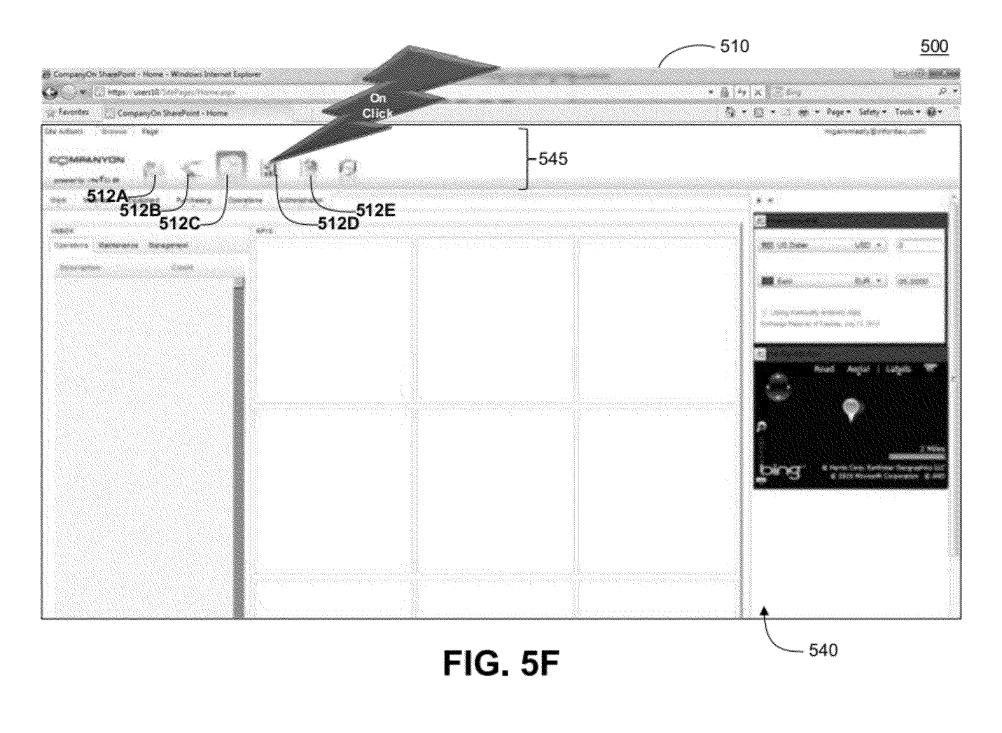

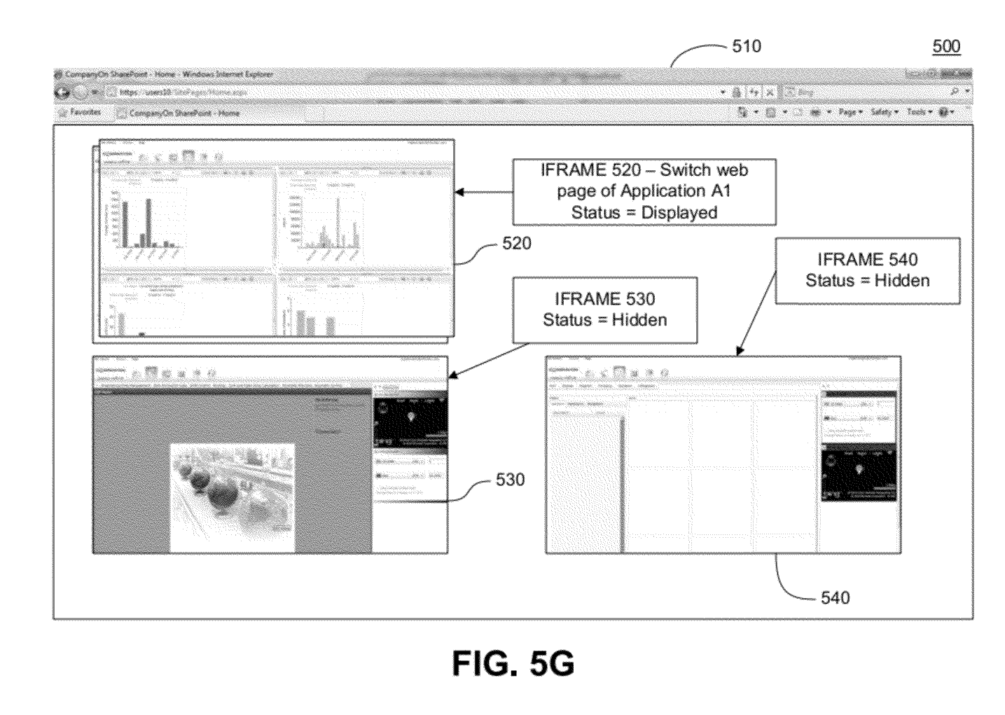

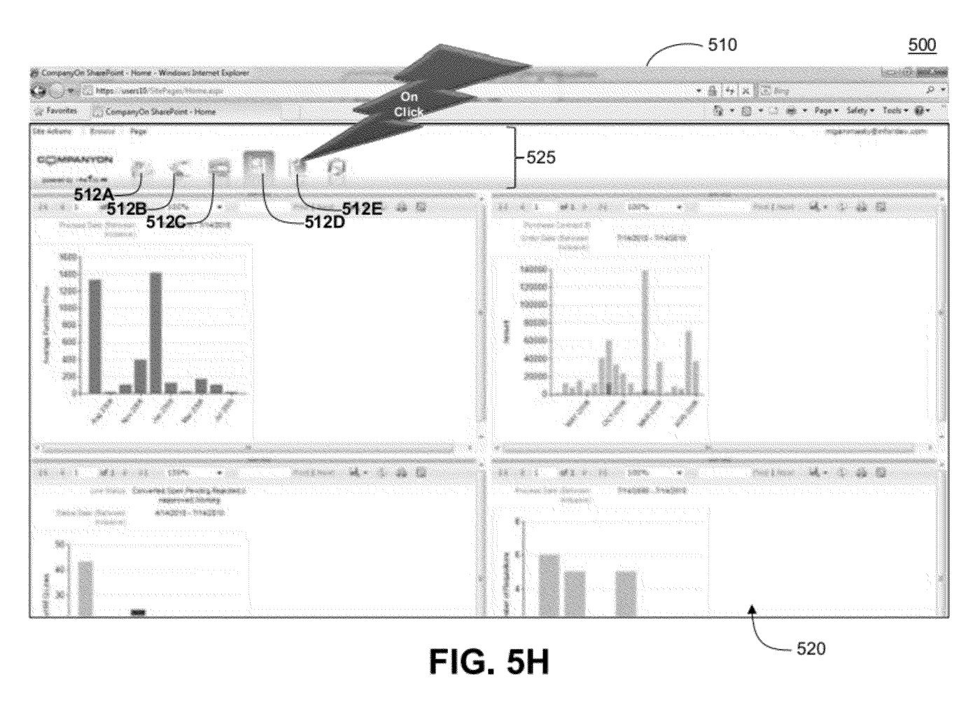

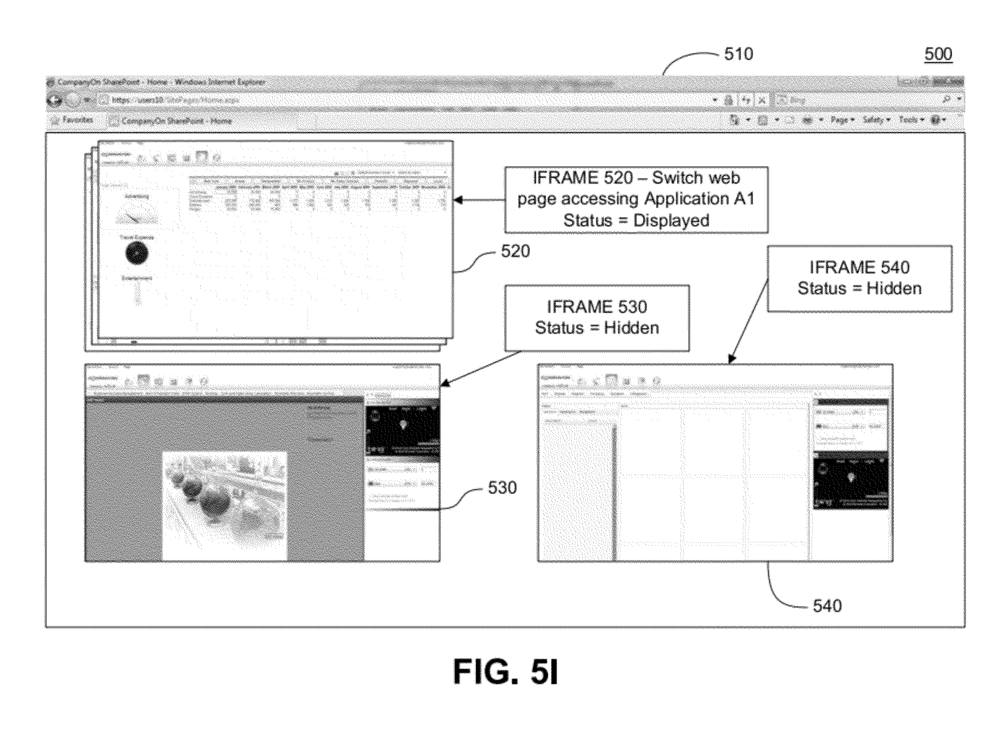

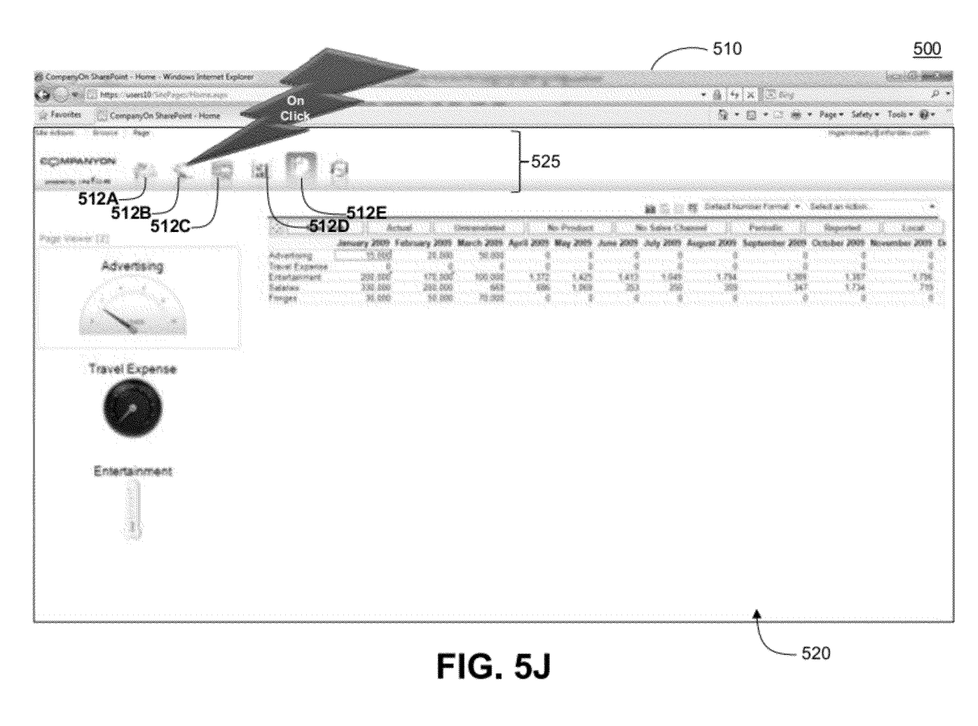

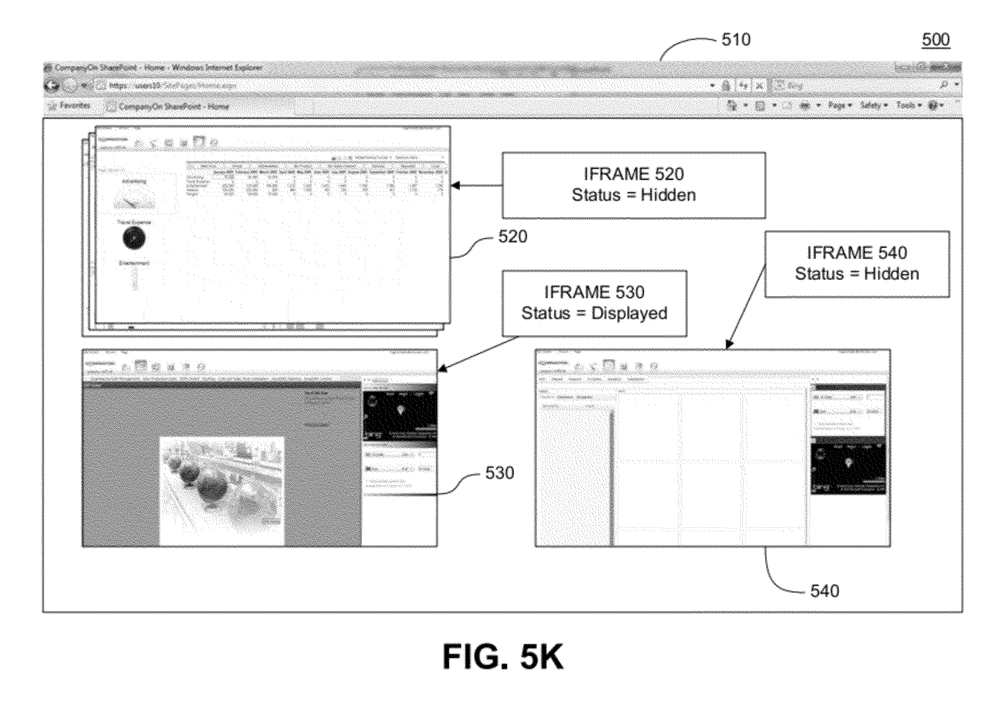

Referring now to FIGS. 5A-5K, there is illustrated a browser 500 displaying a web page 510, in accordance with an exemplary embodiment of the present invention. FIGS. 5A-5K illustrate an example of seamless navigation among a plurality of web applications A1, B1, and C1. It is to be understood that the seamless navigation among the plurality of web applications A1, B1, and C1 illustrated in FIGS. 5A-5K may be accomplished using the method 600A or the method 600B or the exemplary alternative embodiments thereof described above and that the web page 510 is hosted by the server 250 as the web page 110 is hosted by the server 250, as described above.

Beginning with FIG. 5A, there is illustrated the browser 500 connecting to the server 250 and receiving the web page 510. The web page 510 comprises a first frame 520, which is created when the browser 500 receives and renders the web page 510. Specifically, the browser 500 creates the instance of the frame 520 after receiving the web page 510 from the application server 250. The browser 510 then sets the status of the frame 520 to being displayed, i.e., unhidden. As illustrated in FIG. 5A, the first frame 520 accesses a first web application A1. It is to be understood that the web application A1 is served by the server 250.

FIG. 5B illustrates the browser 500 displaying the first frame 520 and an interface to a first web page of the web application A1 within the frame. The first frame 520 comprises an application navigation bar 525, analogous to the application navigation bar 125 of the first frame 120 illustrated in FIG. 1. The application navigation bar 525 comprises a plurality of links 512A-512E to web applications available for access within the browser 500. The application link 512A is a link to a first web page of web application A1 accessed within the frame 510, as illustrated in FIG. 5B. The application link 512B is a link to a web application B1 accessed within the frame 530, as illustrated in FIG. 5D. The application link 512C is a link to a web application C1 accessed within the frame 540, as illustrated in FIG. 5F. The application link 512D is a link to a second web page of web application A1 accessed within the frame 520, as illustrated in FIG. 5H. The application link 512E is a link to a third web page of web application A1 accessed within the frame 520, as illustrated in FIG. 5J.

In the frame 520, when a user clicks on the link 512B within the application navigation bar 525, an OnClick event is triggered, as illustrated in FIG. 5B, and the browser 500 seamlessly navigates to the web application B1 corresponding to the link 512B, in accordance with exemplary methods 600A or 600B or the exemplary alternative embodiments thereof described above. To do so, the browser 500 creates the frame 530, as illustrated in FIG. 5C, and sets the status of the frame 530 to being displayed, i.e., unhidden, and seamlessly sets the status of the frame 520 to being hidden. FIG. 5D illustrates the browser 500 displaying the second frame 530 interfacing with the web application B1.

In the frame 530, when a user clicks on the link 512C within the application navigation bar 535, an OnClick event is triggered, as illustrated in FIG. 5D, and the browser 500 seamlessly navigates to the web application C1 corresponding to the link 512C, in accordance with exemplary methods 600A or 600B or the exemplary alternative embodiments thereof described above. To do so, the browser 500 creates the frame 540, as illustrated in FIG. 5E, and sets the status of the frame 540 to being displayed, i.e., unhidden, and seamlessly sets the status of the frame 530 to being hidden. FIG. 5F illustrates the browser 500 displaying the third frame 540 interfacing with the web application C1.

In the frame 540, when a user clicks on the link 512D within the application navigation bar 545, an OnClick event is triggered, as illustrated in FIG. 5F, and the browser 500 seamlessly navigates to a second web page of the web application A1 corresponding to the link 512D, as illustrated in FIG. 5G, in accordance with exemplary methods 600A or 600B or the exemplary alternative embodiments thereof described above. In the exemplary embodiment illustrated in FIG. 5G, the browser 500 does not create the frame 520, as it has previously created the frame when the browser 500 initially loaded the web page 510. Instead, the browser 500 sets the status of the frame 520 to being displayed, i.e., unhidden, and seamlessly sets the status of the frame 540 to being hidden. FIG. 5H illustrates the browser 500 displaying the first frame 520 accessing the second web page of the web application A1.

In the frame 520, as illustrated in FIG. 5H, when a user clicks on the link 512E within the application navigation bar 525, an OnClick event is triggered and the browser 500 seamlessly navigates to a third web page of the web application A1 corresponding to the link 512E, as illustrated in FIG. 5I, in accordance with exemplary methods 600A or 600B or the exemplary alternative embodiments thereof described above. In the exemplary embodiment illustrated in FIG. 5I, the browser 500 does not create the frame 520, as it has previously created the frame when the browser 500 initially loaded the web page 510. Further, it does not hide or unhide any frames because the user is navigating among web pages within the same frame, i.e., among web pages within the same web application A1. Thus, the browser 500 simply loads the third web page of the web application A1 within the frame 520, as illustrated in FIG. 5J.

As used herein, a web page displayed within a frame accessing a web application is referred to as a “view.” Thus, the web page displayed within the frame 520 in FIGS. 5A and 5B is a first view in the application A1; the web page displayed within the frame 520 in FIGS. 5G and 5H is a second view in the application A1; and the web page displayed within the frame 520 in FIGS. 5I and 5J is a third view in the application A1. The web page displayed within the frame 530 in FIGS. 5C and 5D is a first view in the application B1. The web page displayed within the frame 540 in FIGS. 5E and 5F is a first view in the application C1. It is to be understood that the methods and systems described herein may be used to navigate among different views within the same application and between and among view of different applications.

In the frame 520, as illustrated in FIG. 5J, when a user clicks on the link 512B within the application navigation bar 525, an OnClick event is triggered and the browser 500 seamlessly navigates to the web application B1 corresponding to the link 512B, as illustrated in FIG. 5K, in accordance with exemplary methods 600A or 600B or the exemplary alternative embodiments thereof described above. In the exemplary embodiment illustrated in FIG. 5K, the browser 500 does not create the frame 530, as it has previously created the frame 530 when the browser 500 seamlessly navigated from the frame 520 to the frame 530. Instead, the browser 500 sets the status of the frame 530 to being displayed, i.e., unhidden, and seamlessly sets the status of the frame 520 to being hidden. The frame 530 accesses the web application B1 again.

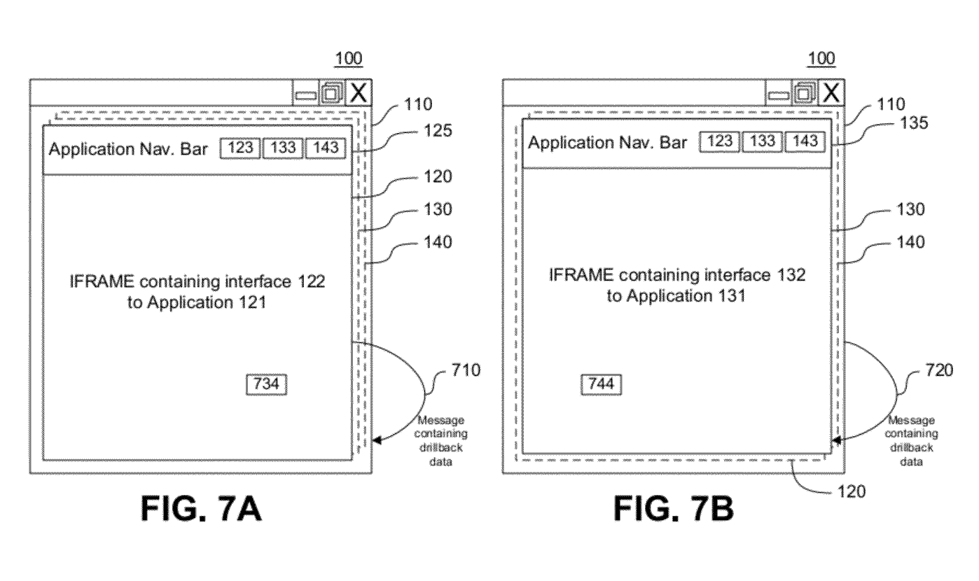

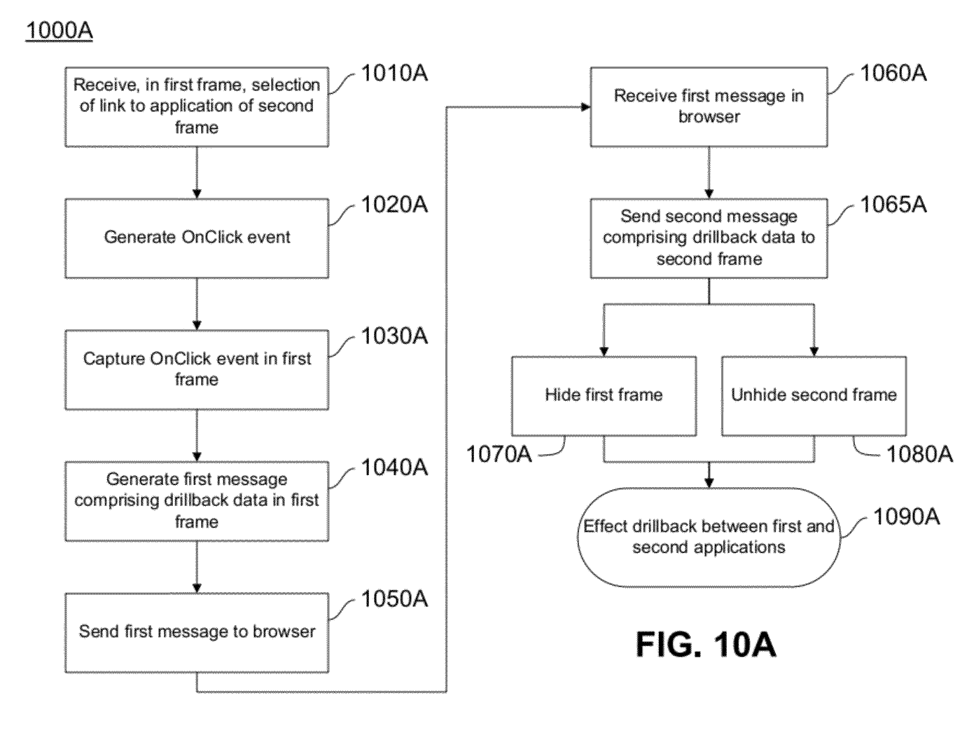

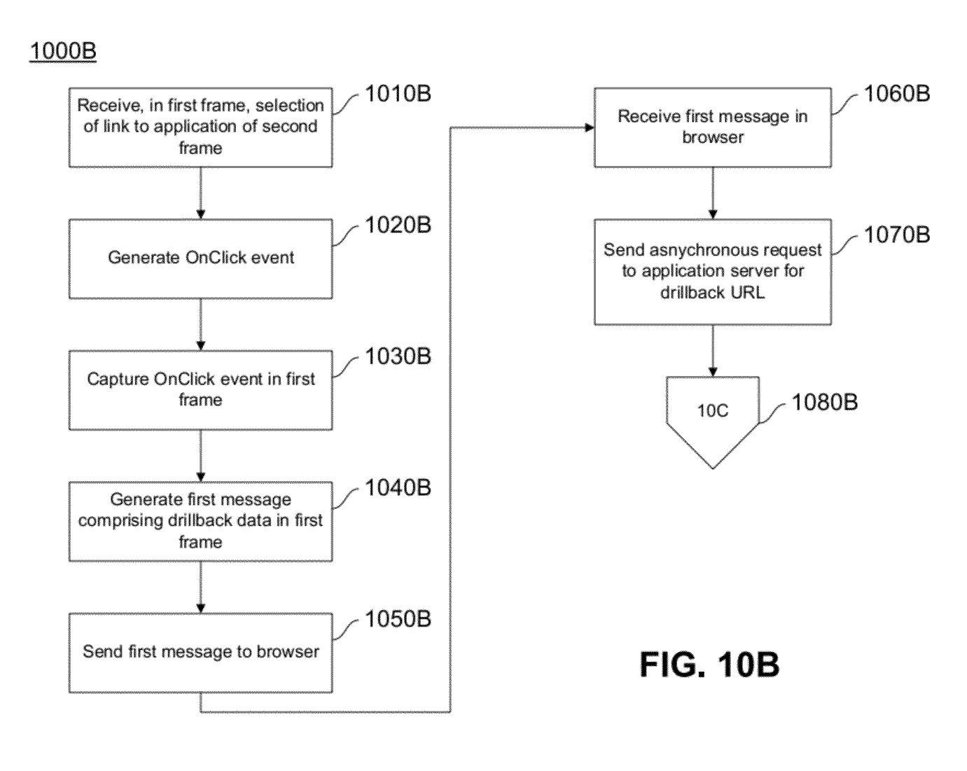

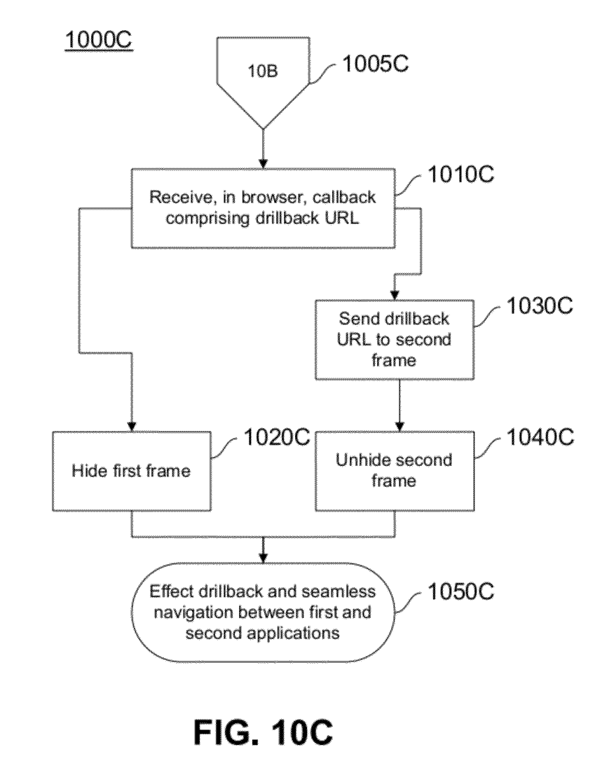

Referring now to FIGS. 7A and 7B, there are illustrated messages sent within the browser 100 to send drill back data between applications, in accordance with an exemplary embodiment of the present invention. FIGS. 7A and 7B are now described with reference to FIG. 10A, which illustrates a first method 1000A of sending drill back data among the applications 121, 131, and 141 using the messages illustrated in FIGS. 7A and 7B, in accordance with an exemplary embodiment of the present invention.

FIG. 7A illustrates a first message 710 sent by the first frame 120 to the browser 100. The first message 710 comprises drill back data specifying data currently displayed within the frame 120. In an exemplary embodiment, such drill back data comprises data inputted into the frame 120 by the user of the browser 100. Also illustrated in FIG. 7A is a link 734 within the frame 120. The link 734 is a drill back link which links to the web application 131 accessed within the interface 132 and, specifically, links to a particular object of the application 131. Operation of the link 734 is described below.

FIG. 7B illustrates a second message 720 sent by the browser 100 to the second frame 130. The second message 720 comprises the drill back data specified in the first message 710. As described below with respect to FIG. 10A, the second message 720, or more specifically the drill back data contained in such message, provides context information for the object of the application 131 selected in the first web application 121. The browser 100 loads the drill back data within the frame 130, as appropriate. Thus, FIG. 7B also illustrates a result of drilling back from the first application 121 to the second application 131. The drilling back is performed in conjunction with seamless navigation from the first web application 121 to the second application 131 using any of the methods described above.

The method 1000A of drilling back from the first application 121 to the second application 131, for example, is now described with reference to FIGS. 7A and 7B. When the browser 100 is in its initial state, the web page 110 displays the first frame 120 and the first application 121 accessed within it, as illustrated in FIG. 7A. The second frame 130 and the third frame 140 are hidden from view. In a Step 1010A, the user clicks or selects the link 734 within the first frame 120. In the examples illustrated in FIGS. 7A-7B, the first link 734 is directed to an object of the second application 131.

The selection of the link 734 generates an OnClick event, Step 1020A. The first frame 130 captures the OnClick event, Step 1030A, and, in response, generates the first message 710 comprising the drill back data, Step 1040A. In an exemplary embodiment, the first message 710 comprises an Java object comprising the following data: (1) a logical ID, which is used to determine the application 131 which will receive the message 710, (2) a view ID, which indicates the current view of the browser 100, i.e., the context (source) of the drill back data, (3) a plurality of IDs which comprise the drill back data, i.e., the data which will be displayed within the application 131, and, optionally, (4) location, and (5) accounting entity.

Continuing with the method 1000A, after generating the first message 710, the first frame 120 sends the first message 710 to the browser 100, Step 1050A. The browser 100 receives the first message 310 and analyzes the contents of the first message 710, Step 1060A. In the example illustrated in FIGS. 7A and 7B, the browser 100 determines that the first message 710 comprises a view ID specifying the first frame 120 as generating the message 710 and a logical ID specifying the application 131 which will receive the drill back data of the first message 710. As a result of such analysis, the browser 100 sends the second message 720 to the second frame 130 comprising the contents of the first message 710, Step 1065A.

The browser 100 then hides the first frame 120, Step 1070A, and unhides the second frame 130, Step 1080A, using the methods described above with respect to FIGS. 3A, 3B, 4A, 4B, 6A, and 6B to effect a seamless navigation between the frames 120 and 130. The second frame 130 loads the drill back data from the message 720 to effect seamless drill back from the first application 121 to the second application 131, Step 1090A.

It is to be understood that drilling back between applications 121, 131, and 141 is performed in conjunction with the seamless navigation among these applications. Thus, in addition to drill back data being sent between applications in accordance with the exemplary method 1000A, seamless navigation between the applications is also accomplished, in accordance with the methods 600A or 600B as indicated by the Steps 1070A and 1080A of the method 1000A. It is to be understood, that the methods 600A or 600B may be performed at the same time as the method 1000A is performed. Thus, when the link 734 is selected, the first message 710 may be sent at the same time the OnClick message 310 is sent. Any of the exemplary embodiments and exemplary alternative embodiments of the methods 600A or 600B may be employed.

As used herein, the term “drill back data” is contextual data regarding a selected application object. For example, if the frame 120 is presently interfacing with a web application providing particulars on a sales order, the drill back data may be information identifying the sales order currently displayed on the browser 100 in the first frame 120. The frame 120 sends the first message 710 containing the sales order information to the browser 100 for drilling back to the sales order object definition displayed in the second frame 130. As another example, if the frame 120 is presently interfacing with a web application providing particulars on a specific task associated with a shipment from a task list, the drill back data may be information identifying the shipment currently displayed on the browser 100 in the first frame 120. The frame 120 sends the first message 710 containing the shipment information to the browser 100 for drilling back to the shipment object definition displayed in the second frame 130.

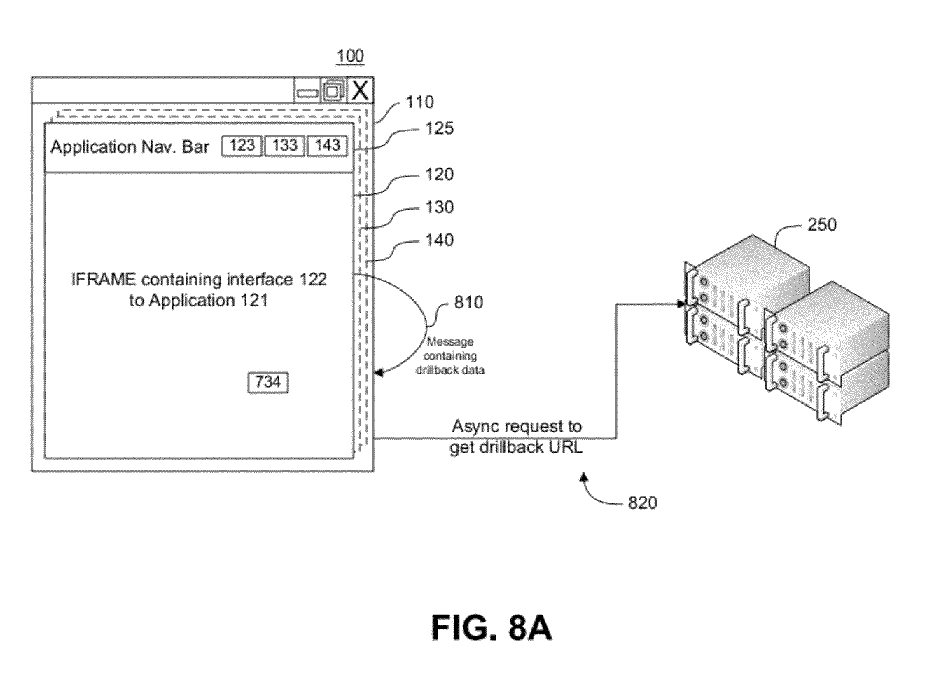

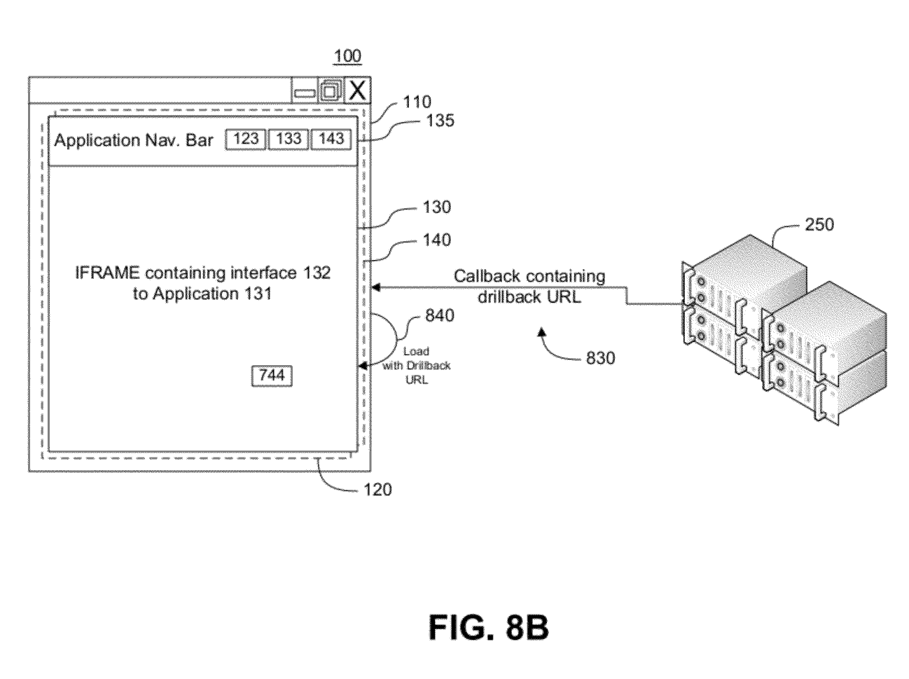

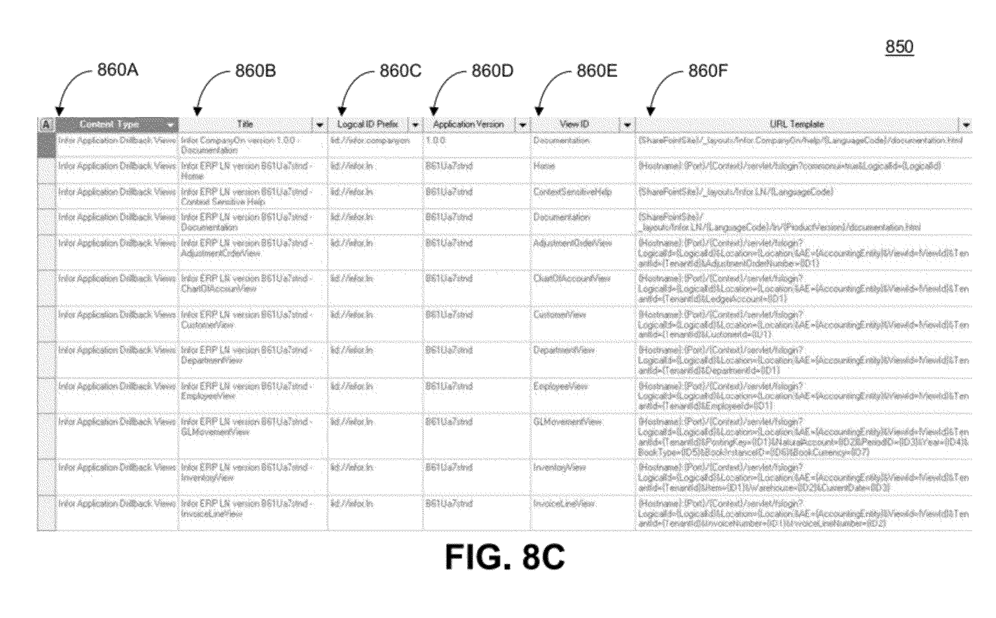

Referring now to FIGS. 8A and 8B, there are illustrated messages sent between the browser 100 and the server 250 to effect drill back data between applications, in accordance with an exemplary embodiment of the present invention. FIGS. 8A and 8B are now described with reference to FIGS. 10B and 10C, which illustrate a second method 1000B and a third method 1000C of sending drill back data among the applications 121, 131, and 141 using the messages illustrated in FIGS. 8A and 8B, in accordance with an exemplary embodiment of the present invention.

FIG. 8A illustrates a first message 810 sent by the first frame 120 to the browser 100 and a second message 820 sent by the browser 100 to the server 250. The first message 810 comprises drill back data specifying data currently displayed within the frame 120. In an exemplary embodiment, such drill back data comprises data inputted into the frame 120 by the user of the browser 100. The second message comprises an asynchronous request to get a drill back URL from the server 250. In an exemplary embodiment, the drill back URL is the address of the web application which is to be accessed by the second frame 130 with the drill back data specified in the message 810. FIG. 10B illustrates a method of generating the messages 810 and 820 and sending the message 820 to the server 250.

FIG. 8B illustrates a third message 830 sent by server 250 to the browser 100. The third message 830 is a callback message comprising the drill back URL requested by the message 820. FIG. 8B additionally illustrates a command 840 sent by the browser 100 to the frame 130 to load the drill back URL. FIG. 10C illustrates a method of receiving the message 830 and effecting drill back.

As described below with respect to FIG. 10C, the drill back URL causes the browser 100 to load the drill back URL in the second frame 130. The server 250 assembles the drill back URL according to the request in the message 820. In an exemplary embodiment, the server 250 executes an application, which delivers the web page 110 to the computer system 210 and which assembles the drill back URL. The application maintains a table 250 of drill back view definitions illustrated in FIG. 8C.

Thus, FIG. 8B also illustrates a result of drilling from the first application 121 to the second application 131. The drilling back is performed in conjunction with seamless navigation from the first application 121 to the second application 131 using any of the methods described above. The seamless navigation appears to the user as the contents of the webpage outside of the application navigation bar 125 being replaced after the link 743 is clicked within the first frame 120.

The method 1000B of sending a request for a drill back URL to the server 250, is now described with reference to FIG. 8A. When the browser 100 is in its initial state, the browser window 110 displays the first frame 120 and the first application 121 accessed within it. The second frame 130 and the third frame 140 are hidden from view. In a Step 1010B, the user clicks or selects the link 734 within the first frame 120. In the example illustrated in FIG. 8A, the first link 734 is directed to an object of the second application 131.

The selection of the link 734 generates an OnClick event, Step 1020B. The first frame 130 captures the OnClick event, Step 1030B and, in response, generates the first message 810 comprising the drill back data, Step 1040B. In an exemplary embodiment, the first message 810 comprises an Java object comprising the following data: (1) a logical ID, which is used to specify the application 131 to which the browser 100 to navigate, (2) a view ID, which indicates the view of the application 131 to which the browser 100 will navigate, (3) a plurality of IDs which comprise the drill back data, i.e., the data which will be displayed within the application 131, and, optionally, (4) location, and (5) accounting entity.

Continuing with the method 1000B, after generating the first message 810, the first frame 120 sends the first message 810 to the browser 100, Step 1050B. The browser 100 receives the first message 810 and analyzes the contents of the first message 810, Step 1060B. In the example illustrated in FIG. 8A, the browser 100 determines that the first message 810 comprises a view ID specifying the first frame 120 as generating the message 810 and a logical ID specifying an object within the application 131 which will receive the data of the first message 810. As a result of such analysis, the browser 100 places an asynchronous request to get a drill back URL for the application 131 via the second message 820, Step 1070B. The server 250 receives the second messages 820, determines the URL corresponding to the request, and sends the callback with the requested drill back URL in the message 830. The method 1000B continues to the method 1000C via a Step 1080B.

The method 1000C of receiving a callback with the requested drill back URL from the server 250 is now described with reference to FIG. 8B. The method 1000C continues from the method 1000B via a Step 1005C. The browser 100 receives the message 830 from the application server 250 and analyzes the contents of the message 830, Step 1010C. In the example illustrated in FIG. 8B, the browser 100 determines that the message 830 comprises a drill back URL for the second frame 130. As a result of such analysis, the browser 100 sends the load command 840 to the second frame 130 to load the drill back URL, Step 1030C. The second frame 120 receives the drill back URL and loads it.

The browser 100 then hides the first frame 120, Step 1020C, and unhides the second frame 130, Step 1040C, using the methods described above with respect to FIGS. 3A, 3B, 4A, 4B, 6A, and 6B to effect a seamless navigation between the frames 120 and 130. The browser 100 thereby effects seamless drill back from the first application 121 to the second application 131, Step 1050C.

It is to be understood that drilling back between applications 121, 131, and 141 in the methods 1000B and 1000C is performed in conjunction with the seamless navigation among these applications. Thus, in addition to drill back data being sent between applications in accordance with the exemplary methods 1000B and 1000C, seamless navigation between the applications is also accomplished, as indicated by the Steps 1050C of the method 1000C. It is to be understood, that the methods 600A or 600B may be performed at the same time as the methods 1000B and 1000C are performed. Thus, when the link 734 is selected, the first message 810 may be sent at the same time the OnClick message 310 is sent. Any of the exemplary embodiments and exemplary alternative embodiments of the methods 600A or 600B may be employed.

Referring now to FIG. 8C, there is illustrated an exemplary table 850 of drill back view definitions, in accordance with an exemplary embodiment of the present invention. The table 850 is maintained by the server 250 or another computer in communication with the server 250 to assemble, between Steps 1070B and 1010C, the drill back URL in the callback message 830 using the request in the message 820. In an exemplary embodiment, the server 250 executes an application, which delivers the web page 110 to the computer system 210 and which assembles the drill back URL between Steps 1070B and 1010C. Such application maintains the table 850 of drill back view definitions illustrated in FIG. 8C.

The table 850 comprises a column 860A describing the content type of each record in the table 850. In the exemplary embodiment of the table 850 illustrated in FIG. 8C, the entire table 850 includes drill back view definitions. Thus, each field in the column 860A identifies each record as “Infor Application Drillback Views.”

The table 850 further comprises a column 860B providing a title for each drill back view. The next column, generally designated as 860C, in the table 850 provides a logical ID prefix for the web application which is the destination of a drill back request, i.e., the logical ID identifies the web application to which the browser 100 will be navigated.

The table 850 further comprises a column 860D, which provides an identification of a version of the web application to which the browser 100 will be navigated and a column 860E, which provides an identification of a view ID. The view ID identifies the view of the web application to which the browser 100 will be navigated. Finally, the table 850 comprises a column 860F, which specifies the URL template for the drill back URL to be provided in the callback message 830. The application which assembles the drill back URL for the callback message 830 accesses the column 860F for a record of the table 850 specified by the asynchronous request 820 to determine the form of the drill back URL. Using the data from the other columns of the specified record and the asynchronous request in the message 820, the application assembles such data into the URL template specified in the column 860F and returns the callback message 830 comprising the drill back URL.

An example of the message 820 is as follows:

http://${SharepointServer}/${SharepointSiteContext}/drillbacks.aspx?logicalID=${LogicalID}
&view=${ViewID}&id1=${ID}&ae=${AccountingEntity}&location=${Location}

An example of the message 830 is as follows:

http://product_server/productb/login.aspx?logicalID=lid://infor.productb.1&view=SalesOrderLin
e&SalesOrderNumber=SO-1001& SalesOrderLineNumber=1&ae=001&location=City

In these examples of messages 820 and 830, the message 820 is a standard URL specifying a logical ID (logicalID=${LogicalID}), a view ID (view=$ {ViewID}), an accounting entity (ae=${AccountingEntity}), a location (location=$ {Location}), and a series of IDs (id1=$ {ID}). The methods 1000A-C convert the standard URL in the message 820 to a product specific URL provided in the message 830. The product specific URL includes any drill back data.

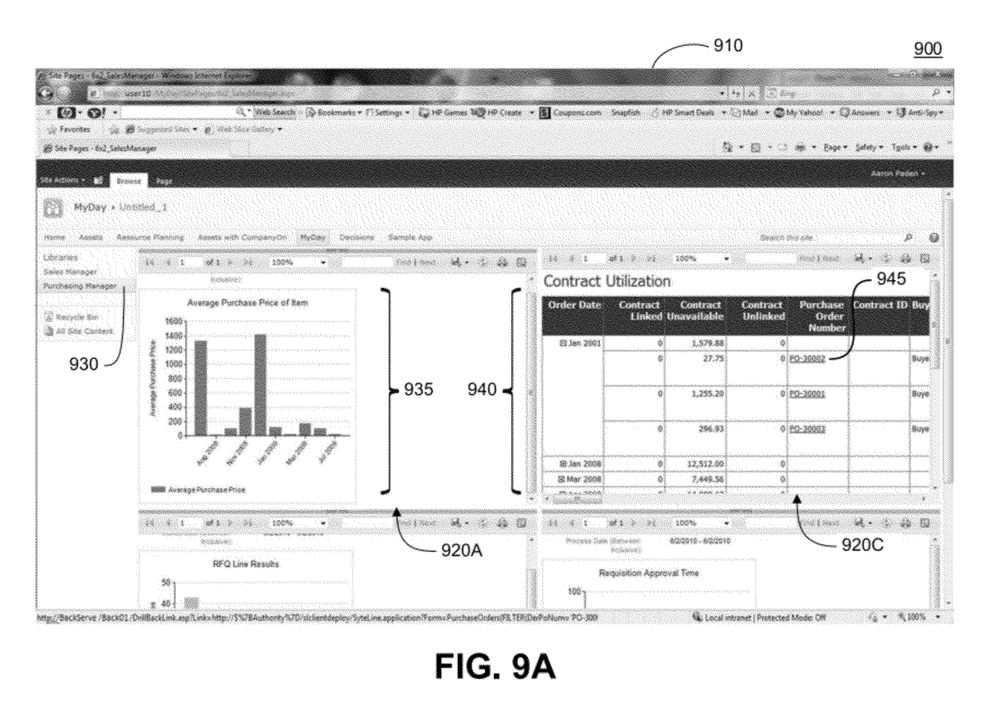

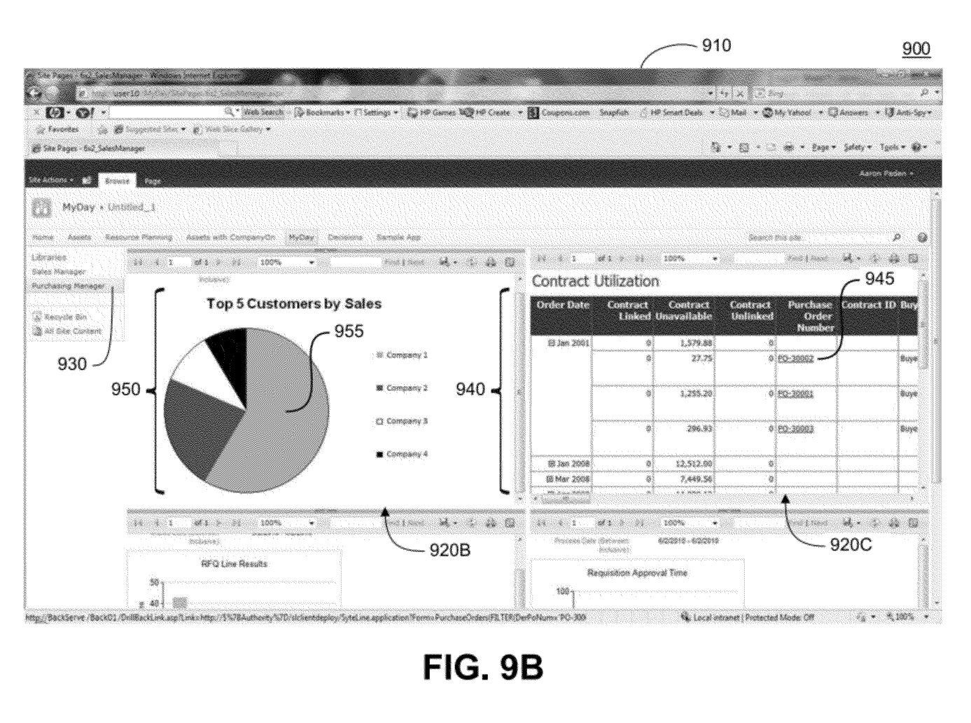

Referring now to FIGS. 9A and 9B, there is illustrated a browser 900 displaying a web page 910 in interfaces 920A through 920C, in accordance with an exemplary embodiment of the present invention. FIGS. 9A-9B illustrate an example of drilling back between web applications accessed in the interfaces 920A and 920B. It is to be understood that the drilling back between web applications accessed in the interfaces 920A and 920B may accomplished using the methods 1000A-C described above and that the web page 910 is hosted by the server 250 as the web page 110 is hosted by the server 250, as described above.

Referring to FIG. 9A, there is illustrated the browser 900 upon connecting to the server 250 and receiving the web page 910. The web page 910 comprises an interface 920A to a first web application and an interface 920C to a different view of the first web application. In the embodiment illustrated in FIG. 9A, the first web application is a reporting service providing a purchasing manager accessed via a link 930. The purchasing manager accessed in the interface 920A comprises various reporting data regarding purchases, such as a chart 935 illustrating average purchase prices for items. The interface 920C provides a table of purchase orders 940, which comprises a plurality of links to each purchase order. One of the links is a link 945 to a purchase order having number PO-30002. Selecting the link 945 causes the browser 900 to seamlessly drill the interface 920A back to a web application providing an interface 920B to the purchase order having number PO-30002. Thus, it is illustrated that drill back may be effected in a view of a web application different from the one in which a drill back request originated. It is to be understood that drill back may also be effected in a web application different from the one in which a drill back request originated.

FIG. 9B illustrates the browser 900 displaying the web page 910 providing the interface 920B. The interface 920A in FIG. 9A is replaced by the interface 920B to a customer-related pie chart 950 showing the top five customers by sales. Each section of the pie chart 950 is a link to a customer definition hosted by another web application or view. Thus, selecting pie section 955 causes the browser 900 to seamlessly drill back to the other web application or view providing an interface to the customer definition for Company 1.

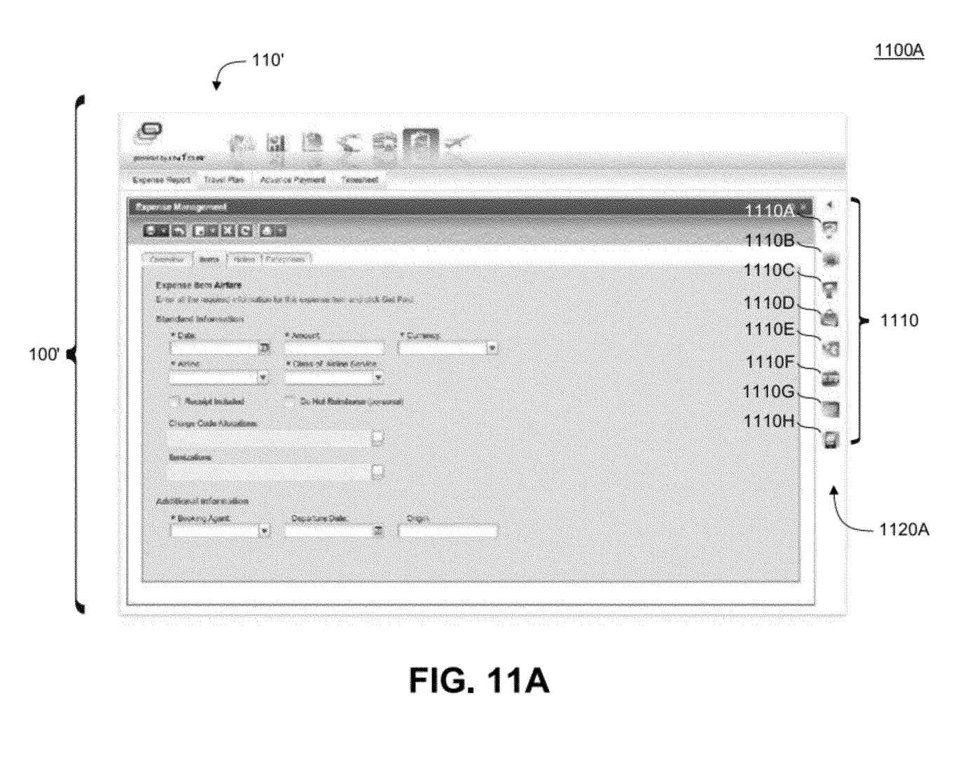

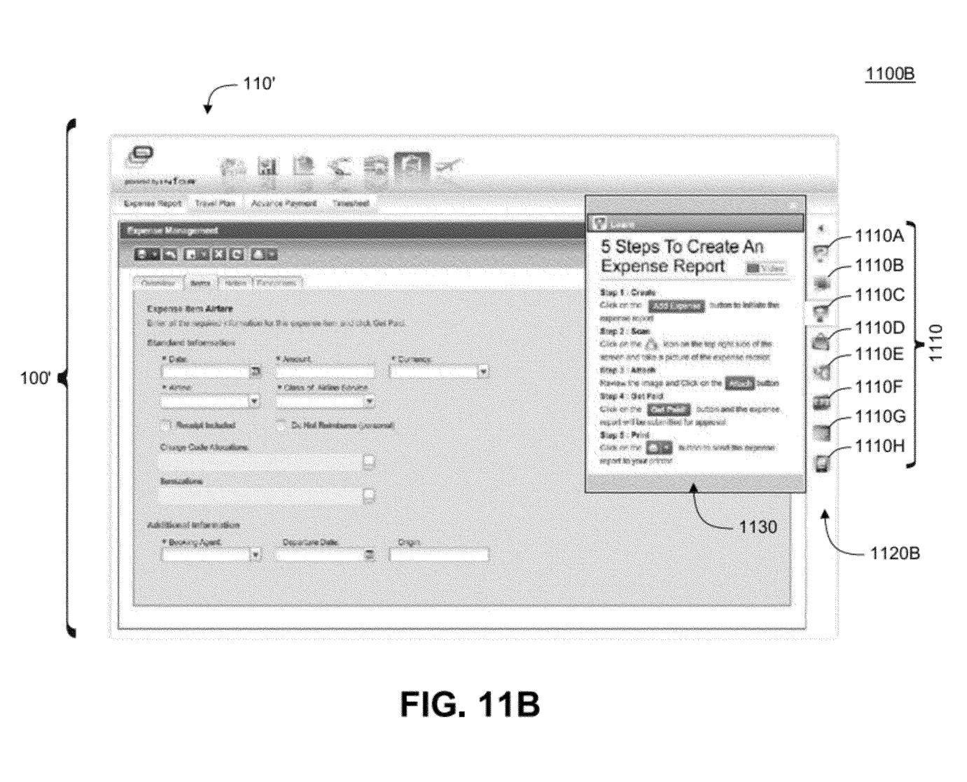

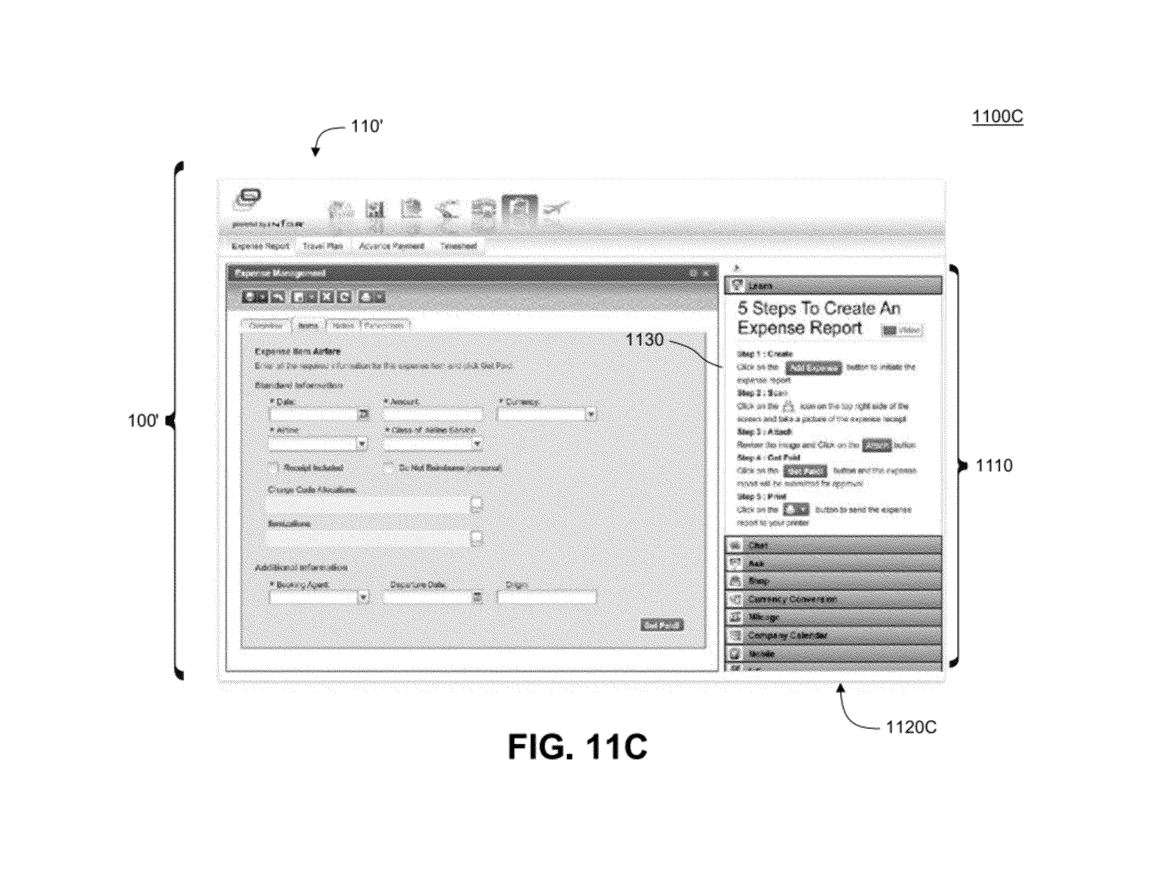

Referring now to FIGS. 11A-11C, there are illustrated differing states of a plurality of right-pane application modules accessed by a right-pane application navigation bar, generally designated as 1110, displayed within alternative embodiments of the web page 110 rendered within the browser 100, generally designated as a web page 110′ rendered within the browser 100′, in accordance with an exemplary embodiment of the present invention. The right-pane application navigation bar 1110 provides a plurality of links 1110A-H to a plurality of gadgets, as that term is known in the art. Each of the links 1110A-H is selectable to reveal the gadget linked by such link. The right-pane application navigation bar 1110 may be rendered in one or more frames separate from the frames 120, 130, and 140 accessed within the browser 100. In an exemplary embodiment, the right-pane application navigation bar 1110 may be rendered within the web page 110 as the application navigation bars 125, 135, and 145 are.

FIG. 11A illustrates a first state 1120A of the right-pane application navigation bar 1110. The first state 1120A is a collapsed state in which none of the links 1110A-H are expanded to present an interface to one of the right pane applications. FIG. 11B illustrates a second state 1120B of the right-pane application navigation bar 1110. In the second state 1120B, one of the right pane applications is expanded into a module overlay state. In the exemplary embodiment illustrated in FIG. 11B, the link 1120C to an application module 1130 is expanded to reveal an interface to the application module 1130. FIG. 11C illustrates a third state 1120C of the right-pane application navigation bar 1110. In the third state 1120C, the application module 1130 is in a pinned state. The remainder of the application modules accessed via the links 1120A-B and 1120D-H are in a collapsed state.

The application modules accessed by the right-pane application navigation bar 1110 may be programmed using techniques known in the art. Such modules may comprise Javascript, Java clients, Flash, AJAX, etc. It is to be understood that the methods of seamless navigation and drilling back may be used to seamlessly navigate to and from the modules accessed by the links 1110A-H and to drill back to and from the modules accessed by the links 1110A-H. Such seamless navigation and drilling back may be to or from one of the web applications 121, 131, and 141, for example, or to and from one of the modules accessed by the links 1110A-H.

It is to be understood that the user interface and the browser 100 are rendered and executed by the computer system 210 upon loading and executing software code or instructions which are tangibly stored on a computer readable medium, such as on a magnetic medium, e.g., a computer hard drive, an optical medium, e.g., an optical disc, solid-state memory, e.g., flash memory, and other storage media known in the art. Thus, any of the functionality performed by the browser 100 and the web page 110 described herein, such as the methods 600A, 600B, and 1000A-C, is implemented in software code or instructions which are tangibly stored on a computer readable medium. Upon loading and executing such software code or instructions by the computer system 210, the computer system 210 may perform any of the functionality of the computer system 210 described herein, including any steps of the methods 600A, 600B, and 1000A-C described herein.

The web applications also comprise software code or instructions which are tangibly stored on a computer readable medium, such as on a magnetic hard drive, optical drive, solid-state memory, and other storage media known in the art. Thus, any of the functionality performed by the computer system 250 described herein, such as hosting web applications, generating the message 830, etc., is implemented in software code or instructions which are tangibly stored on a computer readable medium. Upon loading and executing such software code or instructions by the computer system 250, the computer system 250 may perform any of the functionality of the computer system 250 described herein.

The term “software code” or “code” used herein refers to any instructions or set of instructions that influence the operation of a computer. They may exist in a computer-executable form, such as machine code, which is the set of instructions and data directly executed by a computer's central processing unit, a human-understandable form, such as source code, which may be compiled in order to be executed by a computer, or an intermediate form, such as object code, which is produced by a compiler. As used herein, the term “software code” or “code” also includes any human-understandable computer instructions or set of instructions that may be executed on the fly from a human-understandable form with the aid of an interpreter. Finally, the term “software script” or “script” used herein refers to any computer instructions or set of instructions that may interpreted but do not require compilation into machine code for execution by a computer.

What is claimed is:

1. A computer system connected to a server over a network, the computer system comprising:
a browser comprising a plurality of interfaces configured to access a plurality of applications over the network, the browser configured to:
display contextual data in a first one of the plurality of interfaces accessing a first one of the plurality of applications; and
provide at least a portion of the contextual data to a second one of the plurality of interfaces accessing a second one of the plurality of applications for display in the second one of the plurality of interfaces.

2. The computer system of claim 1, wherein the browser is configured to provide the portion of the contextual data to the second one of the plurality of interfaces while seamless navigation from the first one of the plurality of applications to the second one of the plurality of applications is effected.

3. The computer system of claim 2, wherein the browser is configured to hide the first one of the plurality of interfaces while unhiding the second one of the plurality of interfaces to effect the seamless navigation from the first one of the plurality of applications to the second one of the plurality of applications.

4. The computer system of claim 2, wherein the first one of the plurality of interfaces is configured to hide itself while the second one of the plurality of interfaces is configured to unhide itself to effect the seamless navigation from the first one of the plurality of applications to the second one of the plurality of applications.

5. The computer system of claim 1, wherein the browser further comprises a plurality of frames, each frame executing a respective one of the plurality of interfaces to access a respective one of the plurality of applications over the network, and wherein the browser is configured to:
display the contextual data in a first one of the plurality of frames accessing the first one of the plurality of applications; and
provide at least a portion of the contextual data to a second one of the plurality of frames for display in the second one of the plurality of frames in response to a selection by a user to navigate to the second one of the plurality of applications.

6. The computer system of claim 5, wherein the browser is further configured to provide the portion of the contextual data to the second one of the plurality of frames while effecting seamless navigation from the first one of the plurality of applications to the second one of the plurality of applications.

7. The computer system of claim 1, wherein the browser is further configured to:
transmit a request for navigation to the second one of the plurality of applications based on the displayed contextual data;
receive a response to the request for navigation to the second one of the plurality of applications based on the displayed contextual data; and
navigate to the second one of the plurality of applications based on the response.

8. The computer system of claim 7, wherein:
the request for navigation to the second one of the plurality of applications based on the displayed contextual data comprises a request for an address corresponding to the second one of the plurality of applications based on the displayed contextual data;
the response to the request for navigation to the second one of the plurality of applications based on the displayed contextual data comprises the address corresponding to the second one of the plurality of applications based on the displayed contextual data; and
the browser is further configured to navigate to the address corresponding to the second one of the plurality of applications based on the displayed contextual data.

9. The computer system of claim 1, wherein the browser further comprises a plurality of frames, each frame executing a respective one of the plurality of interfaces to access a respective one of the plurality of applications over the network, the first one of the plurality of frames being unhidden when the browser is navigated to the first one of the plurality of applications and the other ones of the plurality of frames being hidden.

10. The computer system of claim 9, wherein the first one of the plurality of frames comprises a least one link corresponding to another one of the plurality of applications accessed in a respective one of the plurality of interfaces executed in a respective one of the plurality of frames.

11. The computer system of claim 10, wherein the browser is further configured to:
receive a mouse click event identifying a selection of the at least one link in the first one of the plurality of frames; and
seamlessly navigate to the other one of the plurality of applications corresponding to the selected at least one link.

12. The computer system of claim 11, wherein the first one of the plurality of frames is configured to receive the mouse click event and to send a message to the browser, the message comprising an identification of the other one of the plurality of applications to which the browser is to navigate.

13. The computer system of claim 12, wherein the browser is configured to unhide the respective one of the plurality of frames executing the respective one of the plurality of interfaces accessing the other one of the plurality of applications while simultaneously hiding the first one of the plurality of frames to effect seamless navigation from the first one of the plurality of applications to the other one of the plurality of applications accessed in the respective one of the plurality of interfaces executed in the respective one of the plurality of frames.

14. The computer system of claim 10, wherein:
the browser further comprises a browser object comprising at least one method, and
the first one of the plurality of frames is configured to:
receive a mouse click event identifying a selection of the at least one link; and
invoke the at least one method of the browser object to seamlessly navigate to the other one of the plurality of applications corresponding to the selected at least one link.

15. The computer system of claim 14, wherein the method of the browser object is configured to:
transmit a request for navigation to the other one of the plurality of applications corresponding to the selected at least one link based the displayed contextual data;
receive a response to the request for navigation to the other one of the plurality of applications based on the displayed contextual data; and
navigate to the other one of the plurality of applications accessed in the respective one of the plurality of interfaces executed in the respective one of the plurality of frames while unhiding the respective one of the plurality of frames executing the respective one of the plurality of interfaces accessing the other one of the plurality of applications and simultaneously hiding the first one of the plurality of frames to effect seamless navigation from the first one of the plurality of applications to the other one of the plurality of applications.

16. The computer system of claim 15, wherein:
the request for navigation to the other one of the plurality of applications based on the displayed contextual data comprises a request for an address corresponding to the other one of the plurality of applications based on the displayed contextual data;
the response to the request for navigation to the other one of the plurality of applications based on the displayed contextual data comprises the address corresponding to the other one of the plurality of applications based on the displayed contextual data; and
the browser object is further configured to seamlessly navigate to the other one of the plurality applications by accessing the address corresponding to the other one of the plurality of applications in the respective one of the plurality of frames executing the respective one of the plurality of interfaces.

17. A networked computer system, comprising:
a server serving a plurality of applications; and
at least one client-side computer system connected to the server over a network, the at least one client-side computer system comprising a browser comprising a plurality of interfaces configured to access a plurality of applications over the network, the browser configured to:
display contextual data in a first one of the plurality of interfaces accessing a first one of the plurality of applications; and
provide at least a portion of the contextual data to a second one of the plurality of interfaces accessing a second one of the plurality of applications for display in the second one of the plurality of interfaces.

18. The networked computer system of claim 17, wherein the browser is configured to provide the portion of the contextual data to the second one of the plurality of interfaces while seamless navigation from the first one of the plurality of applications to the second one of the plurality of applications is effected.

19. The networked computer system of claim 18, wherein the browser is configured to hide the first one of the plurality of interfaces while unhiding the second one of the plurality of interfaces to effect the seamless navigation from the first one of the plurality of applications to the second one of the plurality of applications.

20. The networked computer system of claim 18, wherein the first one of the plurality of interfaces is configured to hide itself while the second one of the plurality of interfaces is configured to unhide itself to effect the seamless navigation from the first one of the plurality of applications to the second one of the plurality of applications.

21. The networked computer system of claim 17, wherein the browser further comprises a plurality of frames, each frame executing a respective one of the plurality of interfaces to access a respective one of the plurality of applications over the network, and wherein the browser is configured to:
display the contextual data in a first one of the plurality of frames accessing the first one of the plurality of applications; and
provide at least a portion of the contextual data to a second one of the plurality of frames for display in the second one of the plurality of frames in response to a selection by a user to navigate to the second one of the plurality of applications.

22. The networked computer system of claim 21, wherein the browser is further configured to provide the portion of the contextual data to the second one of the plurality of frames while effecting seamless navigation from the first one of the plurality of applications to the second one of the plurality of applications.

23. The networked computer system of claim 17, wherein the browser is further configured to:
transmit a request for navigation to the second one of the plurality of applications based on the displayed contextual data;
receive a response to the request for navigation to the second one of the plurality of applications based on the displayed contextual data; and
navigate to the second one of the plurality of applications based on the response.

24. The networked computer system of claim 23, wherein:
the request for navigation to the second one of the plurality of applications based on the displayed contextual data comprises a request for an address corresponding to the second one of the plurality of applications based on the displayed contextual data;
the response to the request for navigation to the second one of the plurality of applications based on the displayed contextual data comprises the address corresponding to the second one of the plurality of applications based on the displayed contextual data; and
the browser is further configured to navigate to the address corresponding to the second one of the plurality of applications based on the displayed contextual data.

25. The networked computer system of claim 23, wherein the server is configured to:
receive the request for navigation to the second one of the plurality of applications based on the displayed contextual data;
generate the response to the request for navigation to the second one of the plurality of applications based on the displayed contextual data; and
transmit the response to the at least one client-side computer.

26. The networked computer system of claim 17, wherein the browser further comprises a plurality of frames, each frame executing a respective one of the plurality of interfaces to access a respective one of the plurality of applications over the network, the first one of the plurality of frames being unhidden when the browser is navigated to the first one of the plurality of applications and the other ones of the plurality of frames being hidden.

27. The networked computer system of claim 26, wherein the first one of the plurality of frames comprises a least one link corresponding to another one of the plurality of applications accessed in a respective one of the plurality of interfaces executed in a respective one of the plurality of frames.

28. The networked computer system of claim 27, wherein the browser is further configured to:
receive a mouse click event identifying a selection of the at least one link in the first one of the plurality of frames; and
seamlessly navigate to the other one of the plurality of applications corresponding to the selected at least one link.

29. The networked computer system of claim 28, wherein the first one of the plurality of frames is configured to receive the mouse click event and to send a message to the browser, the message comprising an identification of the other one of the plurality of applications to which the browser is to navigate.

30. The networked computer system of claim 29, wherein the browser is configured to unhide the respective one of the plurality of frames executing the respective one of the plurality of interfaces accessing the other one of the plurality of applications while simultaneously hiding the first one of the plurality of frames to effect seamless navigation from the first one of the plurality of applications to the other one of the plurality of applications accessed in the respective one of the plurality of interfaces executed in the respective one of the plurality of frames.

31. The networked computer system of claim 27, wherein:
the browser further comprises a browser object comprising at least one method, and
the first one of the plurality of frames is configured to:
receive a mouse click event identifying a selection of the at least one link; and
invoke the at least one method of the browser object to seamlessly navigate to the other one of the plurality of applications corresponding to the selected at least one link.

32. The networked computer system of claim 31, wherein the method of the browser object is configured to:
transmit a request for navigation to the other one of the plurality of applications corresponding to the selected at least one link based the displayed contextual data;
receive a response to the request for navigation to the other one of the plurality of applications based on the displayed contextual data; and
navigate to the other one of the plurality of applications accessed in the respective one of the plurality of interfaces executed in the respective one of the plurality of frames while unhiding the respective one of the plurality of frames executing the respective one of the plurality of interfaces accessing the other one of the plurality of applications and simultaneously hiding the first one of the plurality of frames to effect seamless navigation from the first one of the plurality of applications to the other one of the plurality of applications.

33. The networked computer system of claim 32, wherein:
the request for navigation to the other one of the plurality of applications based on the displayed contextual data comprises a request for an address corresponding to the other one of the plurality of applications based on the displayed contextual data;
the response to the request for navigation to the other one of the plurality of applications based on the displayed contextual data comprises the address corresponding to the other one of the plurality of applications based on the displayed contextual data; and
the browser object is further configured to seamlessly navigate to the other one of the plurality applications by accessing the address corresponding to the other one of the plurality of applications in the respective one of the plurality of frames executing the respective one of the plurality of interfaces.

34. A method of interfacing to applications over a network, the method comprising steps of:
receiving a plurality of webpages comprising a plurality of interfaces to a plurality of web applications;
rendering a first one of the plurality of webpages within a first one of the interfaces to access a first one of the plurality of web applications, the first one of the plurality of webpages displaying contextual data;
hiding other ones of the plurality of interfaces to hide other ones of the plurality of web applications; and
seamlessly navigating from the first one of the plurality web applications to a second one of the plurality of web applications in a second one of the plurality of webpages rendered in the second one of the plurality of interfaces in response to a user selection, the second one of the plurality of webpages displaying information based on the contextual data presented in the first one of the plurality of webpages.

35. The method of claim 34, the step of seamlessly navigating comprises hiding the first one of the plurality of interfaces while unhiding the second one of the plurality of interfaces.

36. The method of claim 35, wherein the step of seamlessly navigating further comprises:
sending a message to the browser, the message comprising an identification of the second one of the webpages to which the browser is to navigate;
sending a first message from the browser to the first one of the interfaces to hide itself;
sending a second message from the browser to the second one of the interfaces to unhide itself; and
simultaneously hiding the first one of the interfaces in response to the first message from the browser while unhiding the second one of the interfaces in response to the second message from the browser to seamlessly navigate from the first one of the plurality of web applications to the second one of the plurality of web applications.

37. The method of claim 35, wherein the step of seamlessly navigating further comprises:
sending a message to the second one of the plurality of interfaces in response to the user selection; and
simultaneously hiding the first one of the interfaces while unhiding the second one of the interfaces in response to the message to seamlessly navigate from the first one of the plurality of web applications to the second one of the plurality of web applications.

38. The method of claim 35, wherein the step of seamlessly navigating further comprises invoking a method of a browser object in response to the user selection, the method of the browser object simultaneously hiding the first one of the interfaces while unhiding the second one of the interfaces.
